(19) United States
(12) Patent Application Publication
(10) Pub. No.: US 2026/0230746 A1
(43) Pub. Date: Aug. 6, 2026

(54) ACOUSTIC DEVICE AND EAR HOOK HEARING AID DEVICE

(71) Applicant: Shenzhen Shokz Co., Ltd., Shenzhen (CN)

(72) Inventors: Chenyang WU, Shenzhen (CN); Le XIAO, Shenzhen (CN); Fengyun LIAO, Shenzhen (CN); Xin QI, Shenzhen (CN)

(73) Assignee: Shenzhen Shokz Co., Ltd., Shenzhen (CN)

(21) Appl. No.: 19/575,878

(22) Filed: Mar. 23, 2026

Related U.S. Application Data
(63) Continuation of application No. PCT/CN2024/112477, filed on Aug. 15, 2024.

(51) Int. Cl. H04R 1/32; H04R 1/10

(52) U.S. Cl. CPC H04R 1/323; H04R 1/105

(57) ABSTRACT

An acoustic device and an ear hook hearing aid device are provided. The acoustic device is configured to assist a user in acquiring sounds arriving from a neighborhood along a target direction. The acoustic sensor module collects external sound from outside the acoustic device and internal sound emitted from the position of the speaker module to generate sensor signals; the signal processing circuit performs a target operation based on the sensor signals to generate a drive signal; and the speaker module receives the drive signal and outputs speaker sound that satisfies a target sensitivity with respect to the surrounding sound. The target sensitivity is such that, within a preset auditory frequency range, the sensitivity distribution of the acoustic device to external sound is directional and has a maximum value in the target direction, and the speaker sensitivity to internal sound is less than 3 dB.

### RELATED APPLICATIONS

This application is a continuation application of PCT application No. PCT/CN2024/112477, filed on Aug. 15, 2024, and the content of which is incorporated herein by reference in its entirety.

### TECHNICAL FIELD

The present disclosure relates to the field of acoustic technology, and in particular to an acoustic device and an ear hook hearing aid device.

### BACKGROUND

Spatial directivity and howling (feedback) suppression capability are key factors affecting the performance of an acoustic device. Howling is caused by environmental sound collected by an acoustic sensor including sound emitted from a loudspeaker. For example, when a hearing aid device operates, it collects environmental sound through an acoustic sensor, amplifies the environmental sound with gain, and then plays it through a loudspeaker, thereby compensating for a user's hearing loss. When the sound emitted by the loudspeaker is collected again by the acoustic sensor, the hearing aid device forms a closed-loop circuit. As a result, the sound emitted by the loudspeaker is continuously amplified in the closed-loop circuit, causing howling in the hearing aid device and making the user feel uncomfortable. Spatial directivity enables an acoustic device to receive and enhance sound from a specific direction while suppressing sound from other directions, thereby improving the speech recognition capability of the acoustic device and the user's hearing experience in a noisy environment. For example, when a hearing aid operates, the user mainly wants to hear the voice of a speaker located in front of the user. For example, when a singer wears earphones, the user mainly wants to hear the sound produced by the user.

Therefore, it is necessary to provide an acoustic device that simultaneously has good spatial directivity and can avoid or suppress the occurrence of howling.

### SUMMARY

The present disclosure provides an acoustic device and an ear hook hearing aid device. The acoustic device can not only have good spatial directivity, but also achieve effective suppression of howling, providing the user with a better acoustic experience.

In a first aspect, the present disclosure provides an acoustic device. The acoustic device is configured to assist a user in acquiring sound arriving from a neighborhood along a target direction. The acoustic device includes: an acoustic sensor module, including a plurality of acoustic sensors, configured to collect surrounding sound during operation and generate sensor signals, where the surrounding sound includes an external sound from outside the acoustic device and an internal sound emitted from a position of a speaker module; the speaker module, configured to receive a drive signal during operation and output a speaker sound; and a signal processing circuit, communicatively connected to the acoustic sensor module and the speaker module, configured to perform, during operation, a target operation based on the sensor signals to generate the drive signal, such that the speaker sound satisfies a target sensitivity with respect to the surrounding sound, where the target sensitivity is that, within a preset auditory frequency range, a sensitivity distribution of the acoustic device to the external sound is directional and has a maximum value in the target direction, and a speaker sensitivity to the internal sound is less than 3 dB.

In a second aspect, the present disclosure provides an ear hook hearing aid device, including: an acoustic sensor module, including at least 3 acoustic sensors, where the at least 3 acoustic sensors are arranged non-linearly; and a speaker module; when a user wears the hearing aid device, the speaker module is located at a front side of the user's auricle, and the acoustic sensor module is located at a rear side of the user's auricle.

From the above technical solution, it can be seen that the present disclosure provides an acoustic device. The acoustic device is configured to assist a user in acquiring sound arriving from a neighborhood along a target direction. An acoustic sensor module collects surrounding sound and generates a sensor signal, the surrounding sound including external sound from outside the acoustic device and internal sound emitted from the position of the loudspeaker module; the loudspeaker module receives a drive signal and outputs loudspeaker sound; a signal processing circuit performs a target operation based on the sensor signal to generate the drive signal, such that the loudspeaker sound meets a target sensitivity for the surrounding sound, the target sensitivity being a distribution of the acoustic device's sensitivity to external sound within a preset auditory frequency range that has directivity and a maximum value in the target direction, and having a loudspeaker sensitivity to internal sound of less than 3 dB. The acoustic device has a sensitivity of less than 3 dB to internal sound emitted from the position of the loudspeaker module, so that the loudspeaker does not amplify or minimally amplifies the loudspeaker sound received by the acoustic sensor module, thereby achieving suppression of howling. The acoustic device has a maximum sensitivity in the target direction, so that the loudspeaker provides the best amplification effect for external sound in the target direction, thereby having good spatial directivity. In summary, the acoustic device provided by the present disclosure can not only have good spatial directivity, but also achieve effective suppression of howling, providing the user with a better acoustic experience.

Other functions of the acoustic device and the ear hook hearing aid device provided by the present disclosure will be partially listed in the following description. According to the description, the content illustrated by the following figures and examples will be apparent to a person skilled in the art. The inventive aspects of the acoustic device and the ear hook hearing aid device provided by the present disclosure can be fully explained through practice or by using the methods, devices, and combinations described in the detailed examples below.

### BRIEF DESCRIPTION OF THE DRAWINGS

To illustrate the technical solutions in some exemplary embodiments of the present disclosure, specific drawings are briefly introduced below. It is apparent that the drawings described below are only for some exemplary embodiments of the present disclosure, and for a person skilled in the art, other drawings can be obtained based on these drawings without any inventive effort.

FIG. 1A illustrates a schematic appearance diagram of an acoustic device provided according to some exemplary embodiments of the present disclosure;

FIG. 1B illustrates a schematic structural diagram of an acoustic device provided according to some exemplary embodiments of the present disclosure;

FIG. 2 illustrates a schematic diagram of hardware equipment of an acoustic device provided according to some exemplary embodiments of the present disclosure;

FIG. 3 illustrates a schematic sensitivity diagram of an acoustic device provided according to some exemplary embodiments of the present disclosure;

FIG. 4 illustrates a flowchart of a target operation provided according to some exemplary embodiments of the present disclosure;

FIG. 5 illustrates a schematic structural diagram of an acoustic device provided according to some exemplary embodiments of the present disclosure;

FIG. 6A illustrates a schematic sensitivity diagram of an acoustic device provided according to some exemplary embodiments of the present disclosure;

FIG. 6B illustrates a schematic energy comparison diagram under different schemes provided according to some exemplary embodiments of the present disclosure;

FIG. 6C illustrates a schematic feedback comparison diagram under different schemes provided according to some exemplary embodiments of the present disclosure;

FIG. 7A illustrates a schematic sensitivity diagram of an acoustic device provided according to some exemplary embodiments of the present disclosure when three first acoustic sensors are arranged in a straight line;

FIG. 7B illustrates a schematic sensitivity diagram of an acoustic device provided according to some exemplary embodiments of the present disclosure when three first acoustic sensors are arranged non-linearly; and

FIG. 8 illustrates a schematic diagram of an acoustic device and the internal structure of the acoustic device provided according to some exemplary embodiments of the present disclosure.

### DETAILED DESCRIPTION

The following description provides specific application scenarios and requirements of the present disclosure, with the purpose of enabling a person skilled in the art to make and use the content of the present disclosure. For a person skilled in the art, various local modifications to the disclosed embodiments are apparent, and without departing from the spirit and scope of the present disclosure, the general principles defined herein can be applied to some exemplary embodiments and applications. Therefore, the present disclosure is not limited to the illustrated embodiments, but encompasses the broadest scope consistent with the claims.

Unless otherwise defined, all technical and scientific terms used herein have the same meaning as commonly understood by a person skilled in the art to which the present disclosure belongs; the terms used herein are only for the purpose of describing specific embodiments and are not intended to limit the present disclosure. For example, the singular forms “one,” “a,” and “the” as used herein also include the plural forms. When used in the present disclosure, the terms “comprise” and “include,” as well as any of their variations, are intended to cover non-exclusive inclusion. For example, the terms “comprise,” “include,” and/or “contain” mean that the integers, steps, operations, elements, and/or components associated therewith exist, but do not exclude the presence of one or more other features, integers, steps, operations, elements, components, and/or groups, or the addition of other features, integers, steps, operations, elements, components, and/or groups in the system/method.

In the descriptions of the embodiments of the present disclosure, the technical terms “first,” “second,” etc., are used solely to distinguish different objects and should not be understood as indicating or implying relative importance, or as implicitly specifying the number, particular order, or priority relationship of the indicated technical features. In the descriptions of the embodiments of the present disclosure, “plural” means two or more, unless otherwise explicitly and specifically defined.

In the descriptions of the embodiments of the present disclosure, the term “and/or” is merely used to describe the relational association of objects, indicating that three types of relationships may exist. For example, “A and/or B” can indicate: A exists alone, both A and B exist simultaneously, or B exists alone. In addition, the character “/” used herein generally indicates that the objects before and after it are in an “or” relationship.

In the present disclosure, “X includes at least one of A, B, or C” means that X includes at least A, or X includes at least B, or X includes at least C. That is, X may include any combination of A, B, and C, or may include any combination of A, B, and C together with other possible content/elements. Any combination of A, B, and C may be A, B, C, AB, AC, BC, or ABC.

In the present disclosure, unless explicitly stated otherwise, the relational association between structures may be either a direct association or an indirect association. For example, when describing “A is connected to B,” unless it is explicitly stated that A is directly connected to B, it should be understood that A may be directly connected to B or indirectly connected to B. Similarly, when describing “A is above B,” unless it is explicitly stated that A is directly above B (A and B are adjacent and A is above B), it should be understood that A may be directly above B or indirectly above B (other elements exist between A and B, and A is above B). The same principle applies to similar descriptions.

In the descriptions of the embodiments of the present disclosure, the term “plural” refers to two or more (including two); similarly, “multiple sets” refers to two or more sets (including two sets), and “multiple pieces” refers to two or more pieces (including two pieces).

In the descriptions of the embodiments of the present disclosure, the technical terms “center,” “longitudinal,” “lateral,” “length,” “width,” “thickness,” “up,” “down,” “front,” “rear,” “left,” “right,” “vertical,” “horizontal,” “top,” “bottom,” “inner,” “outer,” “clockwise,” “counterclockwise,” “axial,” “radial,” “circumferential,” and the like, which indicate orientation or positional relationships, are based on the orientation or positional relationships shown in the drawings. They are used merely to facilitate the description of the embodiments of the present disclosure and to simplify the description, and are not intended to indicate or imply that the devices or components must have a specific orientation, be constructed in a specific orientation, or operate in a specific orientation, and thus should not be construed as limiting the embodiments of the present disclosure.

In the descriptions of the embodiments of the present disclosure, unless otherwise explicitly stated and limited, the technical terms “mount,” “join,” “connect,” “fix,” and the like should be broadly understood. For example, they may refer to a fixed connection or a detachable connection, or an integrated connection; they may be a mechanical connection or an electrical connection; they may be directly connected or indirectly connected through an intermediate medium; they may refer to communication within two components or an interaction between two components. A person skilled in the art can understand the specific meaning of the above terms in the embodiments of the present disclosure according to the specific context.

In view of the following description, these features of the present disclosure and other features, as well as the operation and function of the relevant structural elements, and the combination and manufacturability of the components, can be significantly improved. With reference to the drawings, all of these form part of the present disclosure. However, it should be clearly understood that the drawings are for illustration and description purposes only and are not intended to limit the scope of the present disclosure. It should also be understood that the drawings are not drawn to scale.

The flowcharts used in the present disclosure illustrate operations implemented by a system according to some exemplary embodiments of the present disclosure. It should be clearly understood that the operations in the flowcharts may not be performed in order. On the contrary, the operations may be performed in reverse order or simultaneously. In addition, one or more additional operations may be added to the flowcharts. One or more operations may be removed from the flowcharts.

For the sake of convenience in description, the following explanation is provided for the terms that will appear in the subsequent description of the present disclosure:

Howling: Howling is a phenomenon in which an acoustic device emits an uncontrollable sharp sound during operation. Typically, howling is caused by self-excitation of the signal in the acoustic device, whose amplitude is infinitely amplified. For example, if an acoustic device includes both a speaker and a microphone, when the microphone collects environmental sounds during operation, and the speaker simultaneously plays sounds, the sounds played by the speaker will also be collected by the microphone. The sound signal collected by the microphone is input to a gain amplifier for gain amplification and then played out through the speaker, thereby forming a “speaker-microphone-speaker” closed-loop in the acoustic system. In this case, when sound signals of certain frequencies undergo self-excited oscillation, howling occurs. Such howling can cause discomfort to the user, and when the howling is severe, it may also damage the acoustic device. In addition, the existence of howling also imposes limitations on the gain amplification factor of a gain amplifier 130, thereby restricting the maximum sound gain that the acoustic device can achieve.

Echo: Echo is also a phenomenon that frequently occurs in acoustic systems. During network transmission, the sound signal emitted by a user at network end A is captured by a microphone and transmitted from end A of the network to end B, then played by the speaker at end B, and further captured by the microphone at end B, and transmitted back to end A through the network. This process requires a certain amount of time, so the user at network end A will hear their own echo. Such echo can affect the normal conversation of the user.

Pickup Directivity Pattern: Refers to a pattern used to characterize the sensitivity of an acoustic sensor/acoustic sensor module to sounds coming from different directions. Simply put, the pickup directivity pattern can characterize the ability of an acoustic sensor/acoustic sensor module to pick up sounds from different directions. Typically, the pickup directivity pattern can include: omnidirectional, cardioid, “8” shaped, supercardioid, and so on.

Null Pickup Direction: In theory, if the sensitivity of an acoustic sensor/acoustic sensor module to sounds from a certain direction and/or a certain position is 0 or close to 0, then that direction and/or position relative to the acoustic sensor/acoustic sensor module is referred to as the null pickup direction. It should be understood that when a sound source is located in the null pickup direction, the acoustic sensor/acoustic sensor module theoretically will not capture the sound emitted by the sound source. In practical situations, due to manufacturing errors of the acoustic sensor/acoustic sensor module and the fact that a real sound source may not be an ideal point, the acoustic sensor/acoustic sensor module can still capture a small amount of sound in the null pickup direction. It should be noted that, in the present disclosure, the null pickup direction can refer to a specific direction, or it can refer to a directional range containing multiple directions.

Sound Field Directivity Pattern: Refers to a pattern used to characterize the sound propagation characteristics of a speaker/speaker module in different directions. Simply put, the sound field directivity pattern can characterize the ability of a speaker/speaker module to propagate sound in different directions.

Null Sound Field Direction: In theory, if the sound pressure of the sound propagated by a speaker/speaker module in a certain direction is 0 or close to 0, then that direction is referred to as the null sound field direction. In the null sound field direction, the sound volume emitted by the speaker/speaker module is 0 or very low. It should be noted that, in the present disclosure, the null sound field direction can refer to a specific direction, or it can refer to a directional range containing multiple directions.

Spatial Directivity: The spatial directivity of an acoustic device refers to the characteristic in which the acoustic device has specific directional features for receiving or transmitting sound in space.

Far-Field Sound Source: Refers to a sound source that is at a relatively long distance from the acoustic sensor/acoustic sensor module. Generally, when the distance between the sound source to be measured and the acoustic sensor/acoustic sensor module is greater than 2-3 times the physical size of the acoustic sensor/acoustic sensor module, the sound source can be approximately considered a far-field sound source. For example, in the scenario of a headphone, a distance greater than or equal to the distance between the wearer's vocal cords and the headphone can be regarded as a far-field sound source. For example, a sound source at a distance greater than 0.1 m, 0.15 m, 0.2 m, or 0.3 m, etc., can be considered a far-field sound source. Compared with a near-field sound source, the sound waves from the far-field sound source are approximately planar, and the amplitude of the sound waves decreases less during propagation. A far-field sound source also refers to a sound source that is at a relatively long distance from a speaker/speaker module.

Near-Field Sound Source: Refers to a sound source that is at a relatively short distance from the acoustic sensor/acoustic sensor module. Generally, when the distance between the sound source to be measured and the acoustic sensor/acoustic sensor module is less than 2-3 times the physical size of the acoustic sensor/acoustic sensor module, the sound source can be approximately considered a near-field sound source. For example, in the scenario of a headphone, a distance less than the distance between the wearer's vocal cords and the headphone can be regarded as a near-field sound source. For example, a sound source at a distance less than 0.3 m, 0.2 m, 0.15 m, or 0.1 m, etc., can be considered a near-field sound source. Compared with the aforementioned far-field sound source, the sound waves from a near-field sound source are closer to spherical, and the amplitude of the sound waves decreases more during propagation. A near-field sound source can also refer to a sound source that is at a relatively short distance from a speaker/speaker module.

The present disclosure is described in detail below through specific exemplary embodiments:

Spatial directivity is one of the key indicators affecting the performance of many acoustic devices. For example, as a type of acoustic device, a hearing aid device relies on the spatial directivity of its acoustic sensor array as a key factor in improving the user's speech recognition ability in noisy environments. Typically, a classic differential microphone array can be realized through a single-side hearing aid device with 2 or 3 acoustic sensor arrays, and its pickup directivity pattern can have shapes such as cardioid and supercardioid, thereby exhibiting a certain degree of directivity.

The physical model of an ideal differential microphone array is based on the far-field plane wave assumption, that is, the wave propagates as a plane wave, the sound intensity does not attenuate during propagation, and the sound signals collected by acoustic sensors at different positions only have a time difference, with the same amplitude and direction. However, the reality is often not like this. The sound intensity received by an acoustic device (such as a hearing aid device) is easily affected by the user's head and other parts of the torso, which means that the received sound is not an ideal plane wave. In addition, the limited number of acoustic sensors in the acoustic device also makes it difficult to achieve a relatively narrow sound wave reception range. Therefore, it is relatively difficult for the acoustic sensor array (such as a microphone array) in a conventional acoustic device (such as a hearing aid device) to achieve good sound collection capability in only a specific direction.

Feedback Reduction/suppression Capability, that is, the ability to prevent howling, is also one of the key indicators affecting the performance of an acoustic device. For example, as a type of acoustic device, a hearing aid device often achieves feedback Reduction/suppression through the configuration of its acoustic sensor array. The feedback that a hearing aid device needs to reduce is usually the sound from the speaker inside the hearing aid device. Since the hearing aid device is generally very small, the distance between its acoustic sensor array (such as a microphone array) and the speaker is usually very close. Therefore, for the acoustic sensor array, the speaker sound is typically a near-field sound source and does not follow the far-field plane wave assumption. By purposefully constructing the acoustic sensor array and, without attenuating speech information, orienting the array nulls toward the feedback sound source, feedback can be reduced.

Since the objectives of spatial directivity and feedback reduction are different, and the beam assumptions they follow are also different, conventional acoustic devices find it difficult to achieve both spatial directivity and feedback reduction simultaneously. The present disclosure provides a solution that achieves both spatial directivity and feedback reduction.

The acoustic device provided in the present disclosure has good spatial directivity and can assist the user in capturing sounds coming from the vicinity along the target direction; at the same time, it can avoid or suppress the occurrence of howling. Furthermore, the acoustic device can also simultaneously avoid or suppress the aforementioned echo phenomenon.

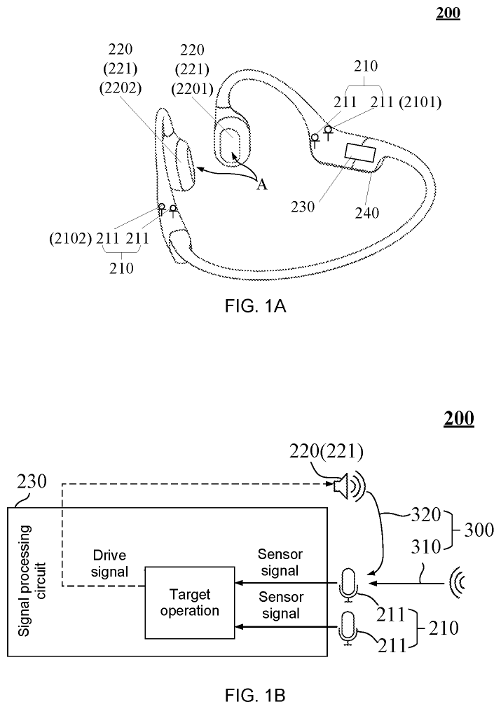

FIG. 1A shows a schematic appearance diagram of an acoustic device 200 provided according to some exemplary embodiments of the disclosure. FIG. 1B shows a schematic structural diagram of an acoustic device 200 provided according to some exemplary embodiments of the disclosure.

In the embodiments shown in FIGS. 1A and 1B, the acoustic device 200 is a rear-hook hearing aid in an ear hook hearing aid. The present disclosure will also primarily describe the rear-hook hearing aid as an example. However, it is understood by a person skilled in the art that other forms of acoustic devices and acoustic devices for other purposes can also adopt the technical solutions of the present disclosure without departing from the present disclosure. For example, the acoustic device 200 can include, but is not limited to, headphones (for example, FIG. 1A), mobile phones, computers, recorders, and so on. The headphones can include, but are not limited to, wired headphones, wireless headphones, Bluetooth headphones, and so on. The headphones can include, but are not limited to, bone-conduction speakers and air-conduction speakers. The acoustic device 200 can also include a hearing aid device. The hearing aid device can include, but is not limited to, an ear hook hearing aid device. The ear hook hearing aid device includes, but is not limited to, a rear-hook hearing aid device. As headphones, the acoustic device 200 can be worn on the user's ear(s).

The acoustic device 200 includes a housing 240, an acoustic sensor module 210, a speaker module 220, and a signal processing circuit 230.

The housing 240 can protect the internal components and facilitate the user in handling and wearing the device. The acoustic sensor module 210, the speaker module 220, and the signal processing circuit 230 are arranged inside the housing 240. Among them, the speaker module 220 is disposed at position A within the housing 240. When the acoustic device 200, as an ear hook hearing aid, is worn on the user's head, the acoustic sensor module 210 is positioned behind the speaker module 220, that is, the speaker module 220 is located on the front side of the user's auricle, and the sound-emitting end of the speaker module 220 faces the user's ear(s), for example, toward the ear canal or the vicinity of the ear canal. The pickup end of the acoustic sensor module 210 is located on the rear side of the auricle. In this way, on one hand, it facilitates the acoustic sensor module 210 to capture environmental sounds, and on the other hand, it minimizes the pickup of sounds emitted by the speaker module 220 by the acoustic sensor module 210.

The acoustic sensor module 210 includes a plurality of acoustic sensors 211. The acoustic sensor 211 can also be referred to as an electroacoustic transducer or a pickup device, used to collect sound and convert the sound into an electrical signal. For example, the acoustic sensor 211 can be a microphone (MIC). The acoustic sensor 211 can be a device that picks up sound based on at least one conduction mode in a gas, liquid, or solid, which is not limited herein. The acoustic sensor 211 can be the MIC itself, or can include the MIC together with its associated simple circuit components.

The speaker module 220 includes one or more speakers 221. The speaker 221 can also be referred to as an electroacoustic transducer, used to convert electrical signals into sound signals. For example, the speaker 221 can be a horn. During operation, the speaker 221 receives an input signal and converts it into audio for playback. Herein, the input signal refers to an electrical signal carrying sound information, and the audio refers to the sound played back by the speaker 221. In some exemplary embodiments, the input signal received by the speaker 221 comes from the acoustic sensor module 210.

In some exemplary embodiments, the input signal received by the speaker 221 can also come from other electronic devices. In some exemplary embodiments, the speaker module 220 includes a plurality of speakers 221. In this case, the plurality of speakers 221 can be arranged in an array. The speaker 220 can be a device that produces sound based on at least one conduction mode in gas, liquid, or solid, which is not limited in the present disclosure. The speaker 220 can be the horn itself, or can include the horn together with its associated simple circuit components.

The signal processing circuit 230 is communicatively connected to the acoustic sensor module 210 and the speaker module 220. During operation, the signal processing circuit 230 performs the target operations described in the present disclosure. The signal processing circuit 230 stores data or instructions for performing the target operations described in the present disclosure, and executes or is used to execute the data or instructions. In some exemplary embodiments, the signal processing circuit 230 includes hardware devices with data processing capabilities and the necessary programs to drive the hardware devices to operate. The aforementioned target operations will be described in detail later.

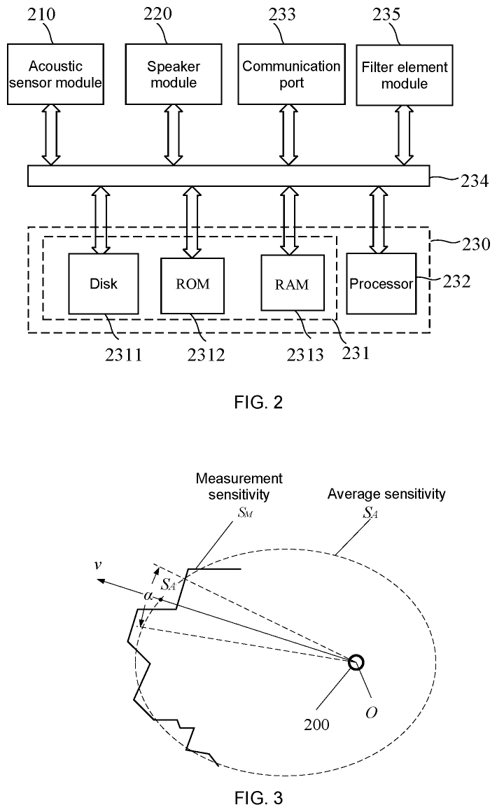

FIG. 2 shows a schematic diagram of the hardware of an acoustic device 200 provided according to some exemplary embodiments of the present disclosure. As shown in FIG. 2, the signal processing circuit 230 includes at least one storage medium 231 and at least one processor 232. The at least one processor 232 is communicatively connected with the at least one storage medium 231 and the acoustic sensor module 210. In some exemplary embodiments, the signal processing circuit 230 is also communicatively connected with the speaker module 220. It should be noted that, for the purpose of illustration, the signal processing circuit 230 in the present disclosure includes at least one storage medium 231 and at least one processor 232. It is understood by a person skilled in the art that the signal processing circuit 230 may also include other hardware circuit structures, which are not limited in the present disclosure, as long as the functions mentioned in the present disclosure can be achieved without departing from the spirit of the disclosure.

In some exemplary embodiments, the acoustic device 200 further includes a communication port 233. The communication port 233 is configured for data communication between the acoustic device 200 and the external environment, for example, for data communication between the acoustic device 200 and other devices/systems. In some exemplary embodiments, the acoustic device 200 further includes an internal communication bus 234. The internal communication bus 234 connects different system components. For example, the speaker module 220, the acoustic sensor module 210, the speaker module 220, the processor 232, the storage medium 231, and the communication port 233 are all connected via the internal communication bus 234.

The at least one storage medium 231 includes a data storage device. The data storage device can be a non-transitory storage medium as well as a transitory storage medium. For example, the data storage device includes one or more of a disk 2311, a read-only memory (ROM) 2312, or a random-access memory (RAM) 2313. The storage medium 231 further includes at least one instruction set stored in the data storage device. The instruction set includes instructions, which are computer program codes, and the computer program codes include programs, routines, objects, components, data structures, procedures, modules, and so on, for performing the target operations provided in the present disclosure. The at least one instruction set is used to generate a drive signal based on a target sensitivity, so that the speaker sound meets the target sensitivity with respect to the surrounding sound.

The at least one processor 232 is configured to execute the at least one instruction set described above and perform the target operation P100 based on sensor signals to generate a drive signal. The target operation P100 will be described in detail later in the present disclosure. When the acoustic device 200 is operating, the at least one processor 232 reads the at least one instruction set and, according to the instructions of the at least one instruction set, performs the target operation P100 provided in the present disclosure. The processor 232 executes all or part of the steps included in the aforementioned target operation. The processor 232 may take the form of one or more processors. In some exemplary embodiments, the processor 232 includes one or more hardware processors, such as a microcontroller, microprocessor, reduced instruction set computer (RISC), application-specific integrated circuit (ASIC), application-specific instruction-set processor (ASIP), central processing unit (CPU), graphics processing unit (GPU), physics processing unit (PPU), microcontroller unit, digital signal processor (DSP), field-programmable gate array (FPGA), advanced RISC machine (ARM), programmable logic device (PLD), any circuit or processor capable of performing one or more functions, or any combination thereof. For ease of illustration and explanation, the example of the acoustic device 200 shown in FIG. 2 includes only one processor 232. However, it should be noted that the acoustic device 200 provided in the present disclosure may also include multiple processors. Therefore, the operations and/or method steps disclosed in the present disclosure may be performed by a single processor or jointly by multiple processors. For example, if the processor 232 of the acoustic device 200 performs step A and step B in the present disclosure, it should be understood that step A and step B may also be executed jointly or separately by two different processors 232 (e.g., the first processor executes step A, the second processor executes step B, or the first and second processors execute steps A and B together).

It is understood by a person skilled in the art that FIG. 2 only illustrates one design scheme of the signal processing circuit 230. The signal processing circuit 230 can also be designed in other hardware forms without departing from the present disclosure. The specific design scheme of the signal processing circuit 230 is not limited in the present disclosure.

The above describes the basic structure of the acoustic device 200.

Referring again to FIGS. 1A and 1B, the operation process of the acoustic device 200 is as follows: the acoustic sensor module 210 collects surrounding sound 300, generates sensor signals, and then sends them to the signal processing circuit 230. The signal processing circuit 230 performs the target operation based on the sensor signals to generate a drive signal and sends it to the speaker module 220. The speaker module 220 receives the drive signal and outputs speaker sound.

According to some exemplary embodiments of the present disclosure, in order to achieve spatial directivity and prevent howling, the acoustic device 200 selectively converts the sensor signals into speaker sound after collecting the surrounding sound 300. For example, the surrounding sound 300 includes external sound 310 from outside the acoustic device 200 and internal sound 320 emitted from position A.

Generally, since the speaker module 220 is located at position A, the internal sound 320 is the sound emitted by the speaker module 220 itself. To prevent howling, the signal processing circuit 230 attenuates or even completely blocks the sensor signals corresponding to the internal sound 320, that is, reduces or eliminates feedback from the internal sound.

At the same time, in order to achieve spatial directivity, the signal processing circuit 230 amplifies or preserves the sensor signals corresponding to external sound 310 from a specific direction (target direction), and preserves or attenuates the sensor signals corresponding to external sound 310 from other directions. The external sound outside the acoustic device 200 includes, but is not limited to, noise present in the environment where the acoustic device 200 is located, sounds emitted by other electronic devices with sound playback functions (e.g., televisions, speakers, mobile phones, etc.), and sounds emitted from a human throat. The sounds emitted from a human throat can include sounds emitted by the throat of a user wearing the acoustic device 200, as well as sounds emitted by the throat of a person communicating with the user. The surrounding sound 300 can be a real sound source or a sound simulation signal. The sensor signals are electrical signals. The sensor signals generated by the acoustic sensor module 210 include external sound signals from external sound 310 and internal sound signals from internal sound 320.

The effect of this is that the acoustic device listens to external sound 310 directionally, while suppressing the sound from the speaker module 220 to prevent howling.

In this regard, for an acoustic device with sound conduction functionality (i.e., a device that collects surrounding sound and plays it back through a speaker), its sensitivity to surrounding sound is defined as the ratio of the sound volume emitted by the speaker on the acoustic device to the corresponding surrounding sound. According to some exemplary embodiments of the present disclosure, the acoustic device 200 in FIGS. 1A and 1B has the following target sensitivity: within a preset auditory frequency range, the sensitivity distribution of the acoustic device 200 to external sound is directional and reaches a maximum in the target direction, and the speaker sensitivity to internal sound is less than 3 dB. In other words, the speaker sound emitted by the acoustic device 200 satisfies the above target sensitivity with respect to the surrounding sound.

It is worth noting that during normal use of the acoustic device 200, although both the internal sound 320 and the speaker sound are emitted by the speaker module 220, the two have different physical concepts. The speaker sound is the sound emitted by the speaker module 220, which contains information of the surrounding sound collected by the acoustic sensor module 210 and conforms to the target sensitivity distribution of the acoustic device 200. The internal sound, on the other hand, is the sound emitted from position A and is the object for which the acoustic device 200 performs feedback reduction. In other words, if the speaker module 220 is removed from the housing 240 and moved to another position, and a third-party speaker is placed at position A, the sound emitted by the third-party speaker, being internal sound, will be suppressed or played at a very low volume by the acoustic device 200.

As described above, within a preset auditory frequency range, the distribution of the sensitivity of the acoustic device 200 to external sounds is directional and has a highest value in a target direction, and has a sensitivity lower than 3 dB to internal sounds.

The preset auditory frequency range may be set according to the purpose of use of the acoustic device 200 and the target user group. For example, when the acoustic device 200 serves as a hearing assistance device and its target user group is people with normal hearing, the preset auditory frequency range is a sound frequency range that normal human ears can hear. For example, the preset auditory frequency range may be 20 Hz to 20000 Hz. In another example, when the acoustic device 200 serves as a hearing aid device and its target user group is people with hearing impairment, the preset auditory frequency range may be a sound frequency range that the ears of people with hearing impairment can hear. For example, due to aging, the hearing range of elderly people may be reduced to 50 Hz to 10000 Hz, in which case the preset auditory frequency range may be 50 Hz to 10000 Hz. In another example, the acoustic device 200 may also be a hearing assistance device customized for an individual user, in which case the preset auditory frequency range is also the sound frequency range that the ears of the single user wearing the acoustic device 200 can actually hear. The acoustic device 200 may be personalized according to different users.

The speaker sound is the sound output by the acoustic device 200. Therefore, the acoustic device 200 satisfying a target sensitivity to surrounding sound may also be expressed as the speaker sound satisfying a target sensitivity to surrounding sound. As described above, sensitivity refers to a ratio of the power of the sound output by an acoustic device to the power of a received sound signal. A larger sensitivity indicates that, for a unit power of a sound signal, the power value of an electrical signal converted by the acoustic device 200 is larger. In some exemplary embodiments, a larger sensitivity may be considered to indicate a larger sound volume.

The distribution of the sensitivity of the acoustic device 200 to external sounds is directional and has a highest value in a target direction. The target direction may refer to one direction, that is, the sensitivity of the acoustic device 200 to external sounds has the highest value within 360° in that direction. In some exemplary embodiments, the target direction may also refer to a range of directions, for example, a neighborhood of a certain direction. FIG. 3 is a schematic diagram of the sensitivity of the acoustic device 200 according to some exemplary embodiments of the present disclosure. As shown by the solid line in FIG. 3, due to the influence of environmental interference and measurement errors, the sensitivity distribution of the acoustic device 200 over 360° obtained through measurement has burrs and is not smooth or continuous. Therefore, the sensitivity of the acoustic device 200 in a direction v is selected as an average value SA of the sensitivities within a listening field range of a certain angle α centered on that direction. Herein, the listening field is a sector region with a reference listening point O as a center and a central angle of a. According to some exemplary embodiments of the present disclosure, the reference listening point O of the acoustic device 200 is the acoustic sensing module 210. Of course, in other cases, the reference listening point may also include at least one of a user's eardrum, the acoustic sensing module 210, or the speaker module 220. The elliptical dashed line in FIG. 3 represents a continuous and/or smooth sensitivity distribution formed by the average value.

Accordingly, the distribution of the sensitivity of the acoustic device 200 to external sounds being directional means that: the average sensitivity of the acoustic device 200 to external sounds within a listening field of a preset angle α has a unique highest value within a 360° range surrounding the acoustic device 200.

The purpose of setting the preset angle is to highlight directionality, so as to eliminate interference factors in measurement, with the objective of obtaining a continuous and/or smooth sensitivity distribution. For example, the preset angle α may be 20°, 15°, 10°, 5°, and the like. The preset angle α of the listening field serves as an indicator of whether the acoustic device 200 has good spatial directionality. For example, the smaller the preset angle, the better the spatial directionality of the acoustic device 200. The larger the preset angle, the more sensitivity measurement points need to be averaged, and the worse the spatial directionality of the acoustic device 200. Acoustic devices 200 with different configurations may use preset angles α of different sizes to better determine directionality.

The reference listening point may be set at different positions. Reference listening points at different positions have different effects on the performance of the acoustic device 200.

According to some exemplary embodiments of the present disclosure, when the reference listening point is the acoustic sensor module 210, the sensitivity of sound within the listening field of the preset angle α is related to a target operation of the signal processing circuit 230. The signal processing circuit 230 performs the target operation on external sounds picked up by the acoustic sensor module 210, so that with a smaller preset angle, the sensitivity in the target direction has the highest value, enabling the acoustic device 200 to have good spatial directionality. The above-mentioned target operation will be described in detail in the following content.

According to some exemplary embodiments of the present disclosure, when the reference listening point is the speaker module 220, the sensitivity of sound within the listening field of the preset angle is associated with a sound field directional pattern of the speaker module 220. That is, the distribution of the sensitivity of the acoustic device 200 to external sounds is directional because the propagation capability of the speaker module 220 for external sounds is directional. The listening field/target direction of the preset angle is a direction or a range of directions in which the speaker module 220 propagates sound most strongly. However, the sound field distribution of a speaker array is also easily affected by the user's head and other body parts, and is limited by the number of speakers 221, making it difficult to achieve a relatively narrow beam range, such that it is difficult to rely solely on the speaker array to achieve good sound propagation capability only in a certain direction. That is, when the preset angle is large, the spatial directionality of the acoustic device 200 is poor.

According to some exemplary embodiments of the present disclosure, when the reference listening point is the speaker module 220, the sensitivity of sound within the listening field of the preset angle is related to a target operation of the signal processing circuit 230. The signal processing circuit 230 performs the target operation on the sound output by the speaker module 220, so that with a smaller preset angle, its ability to propagate sound in the target direction is strongest, enabling the acoustic device 200 to have good spatial directionality. The above-mentioned target operation will be described in detail in the following content.

When the acoustic device 200 is a hearing aid device, the distance between the user's eardrum and the acoustic sensor module 210 or the speaker module 220 is relatively small. Therefore, according to some exemplary embodiments of the present disclosure, when the reference listening point is the user's eardrum, the sensitivity of sound within the listening field of the preset angle is associated with the pickup directional pattern of the acoustic sensor module 210 or with the sound field directional pattern of the speaker module 220. In some embodiments, when the reference listening point is the user's eardrum, the listening field/target direction of the preset angle is the direction or range of directions at which the sound measured at the user's eardrum has the highest volume or is heard most clearly by the user.

The acoustic device 200 has a sensitivity lower than 3 dB to internal sounds. The 3 dB represents a sensitivity that prevents the acoustic device from generating howling. In this case, the volume of the sound in the speaker sound of the acoustic device 200 corresponding to the sound emitted by the speaker module 210 is very low, thereby avoiding or suppressing the occurrence of howling.

The acoustic device 200 may adopt different designs to achieve a sensitivity lower than 3 dB to internal sounds.

According to some exemplary embodiments of the present disclosure, the acoustic device 200 achieves a low sensitivity to internal sounds through the acoustic sensor module 210. For example, the speaker module 220 may be arranged near the null pickup position of the acoustic sensor module 210, or arranged on or near the null pickup direction of the acoustic sensor module 210. In this way, since the acoustic sensor module 210 reduces the pickup of internal sounds, the internal signal components from the speaker module 220 in the sensor signal are reduced, thereby achieving the effect of suppressing howling. It should be noted that, since the speaker module 220 may include multiple speakers, its position will be within a certain range, and the above “arranging the speaker module 220 on or near the null pickup direction of the acoustic sensor module 210” should be understood as the null pickup direction generally pointing toward the speaker module 220. For example, the null pickup direction may point to the center point of the speaker module 220. In another example, the null pickup direction may point to any point on the sound-emitting surface of the speaker module 220. In another example, the null pickup direction may point to a preset area on the sound-emitting surface of the speaker module 220. For example, assuming that the direction angle corresponding to the center point of the speaker module 220 is θ1, the direction angle corresponding to the null pickup direction is within the range [θ1−Δφ1, θ1+Δφ1], where −Δφ1 is a preset field value of the direction angle θ1, the magnitude of which is determined according to the actual design of the acoustic device 200 for the purpose of preventing howling.

According to some exemplary embodiments of the present disclosure, the acoustic device 200 can also achieve a low sensitivity to internal sounds through the speaker module 220. For example, the acoustic sensor module 210 may be located at a null sound field position of the speaker module 220, or the null sound field direction of the speaker module 220 may point toward the acoustic sensor module 210. This means that the internal sound emitted by the speaker module 220 has a volume of 0 or nearly 0 when it reaches the acoustic sensor module 210. Since the speaker module 220 reduces the volume of internal sounds reaching the acoustic sensor module 210, the internal signal components from the speaker module 220 in the sensor signal are reduced (or the signal strength from the speaker module 220 is lowered), thereby achieving the effect of suppressing howling.

It should be noted that the above “null sound field direction pointing toward the acoustic sensor module 210” should be understood as the null sound field direction generally pointing toward the acoustic sensor module 210. For example, the null sound field direction may point to the center point of the acoustic sensor module 210. In another example, the null sound field direction may point to any point on the pickup surface of the acoustic sensor module 210. In another example, the null sound field direction may point to a preset area on the pickup surface of the acoustic sensor module 210. For example, assuming that the direction angle corresponding to the center point of the acoustic sensor module 210 is θ2, the direction angle corresponding to the null sound field direction is within the range [θ2−Δφ2, θ2+Δφ2], where −Δφ2 is a preset field value of the direction angle θ2, the magnitude of which is determined according to the actual design of the acoustic device 200 for the purpose of preventing howling.

According to some exemplary embodiments of the present disclosure, the acoustic device 200 achieves a low sensitivity to internal sounds through the signal processing circuit 230 performing a target operation. The target operation will be described later.

As described above, the distribution of the sensitivity of the acoustic device 200 to external sounds is directional and has a highest value in the target direction. Depending on the specific use of the acoustic device 200 as a hearing assistance device, there may be multiple practices for the orientation of the target direction.

According to some exemplary embodiments of the present disclosure, when the acoustic device 200 is worn on the user's ear(s), the target direction is oriented toward the user's sound-producing location. That is, in the sound output by the acoustic device 200, the volume of the sound produced by the user is the greatest. For example, when a singer is performing, the sound volume at the performance venue may be too high, or the sound of instrumental accompaniment may be too loud, interfering with the accuracy of their own vocalization. Therefore, the singer needs to wear a hearing aid device to help hear their own voice. In this case, the acoustic device 200 may serve as the singer's in-ear monitor. The microphone on the headphone picks up surrounding sounds, and in the speaker sound output by the speaker on the headphone, the singer's own voice is the loudest.

According to some exemplary embodiments of the present disclosure, when the acoustic device 200 is worn on the user's ear(s), the target direction is the direction toward which the user's face is oriented. Accordingly, as shown in the structure of FIG. 1, the target listening field is oriented away from the acoustic sensor module 210. That is, in the sound output by the acoustic device 200, the volume of sound in the direction of the user's face orientation is the greatest. For example, the acoustic device 200 may be a hearing aid device for a user with hearing impairment. Users of this type of hearing aid typically most need to hear the person they are conversing with face-to-face. Therefore, the target direction is set as the direction of the user's face orientation. Of course, for users in special situations, the direction of the user's face orientation may also be in another direction relative to the user's body. For example, a user with a hunchback may have their face oriented toward the ground, while the person they are conversing with is typically in the direction facing the user's forehead. In this case, the target direction may be set as the direction toward which the user's forehead is facing.

As described above, the distribution of the sensitivity of the acoustic device 200 to external sounds is directional, and has a sensitivity lower than 3 dB in a preset direction. Depending on the specific use of the acoustic device 200 as a hearing assistance device, there may be multiple practices for the orientation of the preset direction.

For example, according to some exemplary embodiments of the present disclosure, external sounds include a first external sound and a second external sound. The first external sound is emitted from a first position. The first position is in the target direction, and the sensitivity of the acoustic device 200 to the first external sound is the aforementioned highest value. The second external sound is emitted from a second position. The second position is in the opposite direction along the target direction. The acoustic device 200 has a sensitivity lower than 3 dB to the second external sound. For example, the acoustic device 200 may be a hearing aid device. A user wearing the hearing aid device typically most needs to hear the sound produced by a conversational partner located in front of them. Sounds from behind the user may interfere with the conversation or may be of no interest to the user. Therefore, the acoustic device 200 has a sensitivity lower than 3 dB to sounds behind the user.

At this time, the acoustic device 200 has the highest sensitivity to the first external sound located in the target direction, a lower sensitivity to the second external sound located in the opposite direction of the target direction, and also a low sensitivity to internal sounds. Therefore, the acoustic device 200 can achieve howling suppression while having good spatial directionality.

According to some exemplary embodiments of the present disclosure, external sounds include a first external sound and the second external sound. The first external sound is emitted from a first position. The first position is in the target direction. The second external sound is emitted from a second position, which is the user's own sound-producing location when the user wears the acoustic device. The acoustic device has a sensitivity lower than 3 dB to the second external sound. Since the first position is in the target direction, the acoustic device 200 has the aforementioned highest sensitivity to the first external sound. For example, the acoustic device 200 may be a hearing aid device. As described above, a user wearing the hearing aid device typically most wants to hear the sound produced by a conversational partner located in front of them, and the user generally does not need their own voice to be amplified by the hearing aid. This is because, on one hand, the user clearly knows what they are saying, and their own voice is very close to their ears, and can be heard by the user through multiple pathways such as air conduction and bone conduction. Therefore, the acoustic device 200 may be set to have a sensitivity lower than 3 dB to the user's own voice, thereby suppressing the acoustic device 200 from transmitting the user's own voice. Meanwhile, surrounding environmental sounds, especially sounds produced by conversational partners in front of the user, are enhanced by the acoustic device 200, making it easier for the user to distinguish other voices.

According to some exemplary embodiments of the present disclosure, the acoustic device 200 simultaneously has a sensitivity lower than 3 dB to sounds located in the opposite direction of the target direction as well as to the user's own voice. In some embodiments, the acoustic device 200 simultaneously has a sensitivity lower than 3 dB to three or more sounds, in order to meet the user's communication habits and needs.

The following description of the present disclosure will explain how the acoustic device 200 achieves a directional sensitivity distribution while preventing howling.

According to some exemplary embodiments of the present disclosure, the acoustic sensor module 210 includes K acoustic sensors 211, where K is a positive integer. For example, as shown in FIG. 1B, the acoustic sensor module 210 includes two acoustic sensors 211. In another example, the acoustic sensor module 210 may include three acoustic sensors 211.

As described above, when the acoustic device 200 is an ear hook hearing aid device, the ear hook hearing aid device is worn by the user on the user's ear(s). The user's ears include a first ear and/or a second ear. Accordingly, the acoustic sensor module 210 includes K₁ first acoustic sensors 2101 and/or K₂ second acoustic sensors 2102. The first acoustic sensors 2101 correspond to the first ear; the second acoustic sensors 2102 correspond to the second ear. Here, K₁ and K₂ are both integers, and K₁+K₂=K. For ear hook hearing aid devices equipped on both ears of the user, K₁ and K₂ are both nonzero; for ear hook hearing aid devices equipped only on the user's first ear, K₁=K and K₂=0; for ear hook hearing aid devices equipped only on the user's second ear, K₂=K and K₁=0.

Accordingly, the speaker module 220 also includes first speakers 2201 corresponding to the first ear and/or second speakers 2202 corresponding to the second ear.

According to some exemplary embodiments of the present disclosure, the acoustic sensor module 210 includes only the first acoustic sensors 2101 or only the second acoustic sensors 2102. For example, at the Grammy Awards, the host wears the acoustic device 200 as a wireless headphone and wears only one headphone. The acoustic sensor module 210 may include three acoustic sensors 211. These three acoustic sensors 211 may all be first acoustic sensors 2101 or all second acoustic sensors 2102.

In some embodiments, the acoustic sensor module 210 may simultaneously include first acoustic sensors 2101 and second acoustic sensors 2102. Generally, the number of acoustic sensors 211 included in the first acoustic sensors 2101 and the second acoustic sensors 2102 is equal, but in special situations, they may be unequal. For example, in the case of a user with hearing impairment wearing a hearing aid, the acoustic device 200 may be a wireless headphone. The user wears two headphones, and the acoustic sensor module 210 includes five acoustic sensors. Since the hearing ability of the user's two ears is different, according to the user's actual situation, two of the acoustic sensors 211 are first acoustic sensors 2101, and three of the acoustic sensors 211 are second acoustic sensors 2102.

The following describes how the acoustic device 200, which includes multiple first acoustic sensors 2101 and multiple second acoustic sensors 2102, achieves bilateral feedback reduction and spatial directionality of the sensitivity distribution through the target operation P100. FIG. 5 shows a schematic diagram of the structure of the acoustic device 200 according to some exemplary embodiments of the present disclosure.

A person skilled in the art will understand that achieving unilateral feedback reduction and spatial directionality of the sensitivity distribution by the acoustic device 200 is a special case of the bilateral implementation. After understanding how bilateral feedback reduction and spatial directionality of the sensitivity distribution are achieved, a person skilled in the art can implement unilateral feedback reduction and spatial directionality of the sensitivity distribution according to the same principles.

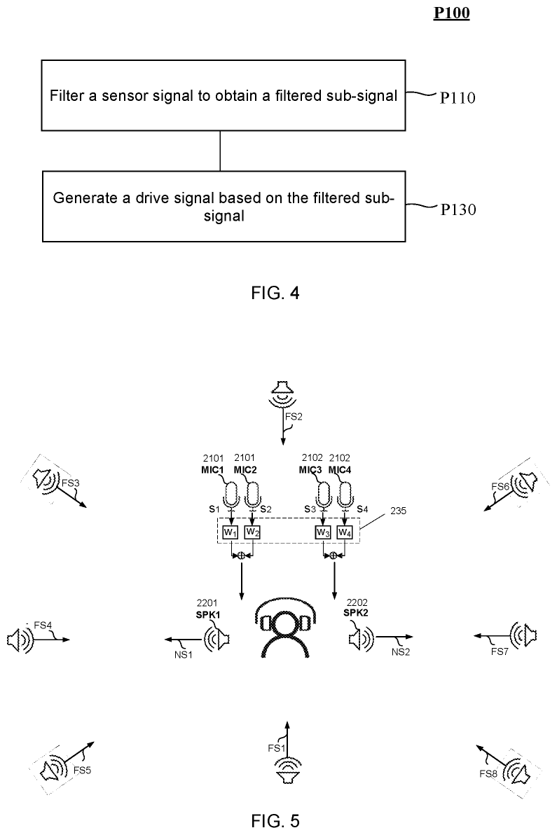

In some exemplary embodiments, when the K acoustic sensors operate, they generate K sub-signals s₁, s₂, . . . , s_{K}. The sensor signal s includes these K sub-signals, s=(s₁, s₂, . . . , s_{K})^{T}. That is, each sub-signal is a sensor signal generated by an acoustic sensor 211 based on surrounding sounds. As described above, when the signal processing circuit 230 operates, it performs a target operation based on the sensor signal to generate a drive signal, so that the speaker sound satisfies a target sensitivity to the surrounding sound. FIG. 4 shows a flowchart of a target operation P100 provided according to some exemplary embodiments of the present disclosure. In order to generate the drive signal based on the sensor signal, the signal processing circuit 230 performs the target operation P100. The target operation P100 includes: P110: Filter a sensor signal s to obtain a filtered sub-signal \tilde{s}.

The filtered sub-signal \tilde{s}=(\tilde{s}₁, \tilde{s}₂, . . . , \tilde{s}_{K})^{T}. The sub-filtered signals \tilde{s}₁, \tilde{s}₂, . . . , \tilde{s}_{K} are K filtered sub-signals corresponding to the K sub-signals. In some exemplary embodiments, filtering the sensor signal s may be implemented through a filter.

According to some exemplary embodiments of the present disclosure, the filtering may be implemented in various ways. For example, the filtering may be performed by the processor 232 in the signal processing circuit 230 of FIG. 2 calling corresponding instructions stored in the memory 231 and executing a filtering processing algorithm based on the instructions. In another example, the filtering may be implemented through a hardware filter 235 in the signal processing circuit 230 of FIG. 2. In this case, the signal processing circuit 230 includes at least one filter element module 235. The at least one filter element module 235 is communicatively connected to the acoustic sensor module 210 and is configured to perform the filtering on the sensor signal during operation. The filter element module 235 includes multiple filters. For example, the filter element module 235 includes K filters, each corresponding to one of the K acoustic sensors 211.

P130: Generate a drive signal d based on the filtered sub-signal \tilde{s}.

The drive signal d has a directional response to external sounds and reaches a highest value in the target direction, while the response of the drive signal d to internal sounds is attenuated to prevent howling of the speaker in the acoustic device 200 during operation.

In some exemplary embodiments, in order to obtain the filtered sub-signal \tilde{s} and generate the drive signal d, the signal processing circuit 230 performs: for each sub-signal sᵢ in the sensor signal s, applying a corresponding amplitude phase modulation wᵢ to generate the corresponding filtered sub-signal \tilde{s}ᵢ in the filtered signal \tilde{s}, where i is any integer from 1 to K. The drive signal d is then obtained based on the sum of the K filtered sub-signals.

By selecting an appropriate amplitude phase modulation w=(w₁, w₂, . . . , wᵢ, . . . , w_{K})^{T}, the first portion of the speaker sound corresponding to the first external sound can remain unattenuated at the reference listening point O, while the second portion in the drive signal d is attenuated to prevent speaker howling and to form the target sensitivity, where the second portion corresponds to the components of the second external sound and internal sounds. The specific implementation will be described later.

The acoustic device 200 includes multiple first acoustic sensors 2101 and multiple second acoustic sensors 2102; in addition, the acoustic device 200 also includes one or more first speakers 2201 and one or more second speakers 2202. Therefore, internal sounds in the acoustic device include a first internal sound and a second internal sound. The first internal sound is emitted from the position of the first speaker 2201. The second internal sound is emitted from the position of the second speaker 2202. The transfer functions from the first internal sound to the K₁ first acoustic sensors are

$${N}_{1}^{1} , {N}_{2}^{1} , … {N}_{{K}_{1}}^{1} .$$

The transfer functions from the first internal sound to the K₂ second acoustic sensors are

$${N}_{{K}_{1} + 1}^{1} , {N}_{{K}_{1} + 2}^{1} , … {N}_{{K}_{1} + {K}_{2}}^{1} .$$

The transfer functions from the second internal sound to the K₁ first acoustic sensors are

$${N}_{1}^{2} , {N}_{2}^{2} , … {N}_{{K}_{1}}^{2} .$$

The transfer functions from the second internal sound to the K₂ second acoustic sensors are

$${N}_{{K}_{1} + 1}^{2} , {N}_{{K}_{1} + 2}^{2} , … {N}_{{K}_{1} + {K}_{2}}^{2} .$$

For example, in FIG. 5, the acoustic sensor module 210 includes two first acoustic sensors 2101 (MIC1 and MIC2, respectively) and two second acoustic sensors 2102 (MIC3 and MIC4, respectively). The acoustic device 200 may have one speaker on each of its left and right sides, the left and right speakers being 2201 (SPK1) and 2202 (SPK2), respectively. The first internal sound NS1 is emitted by SPK1, and the second internal sound NS2 is emitted by SPK2. The sound emitted by a speaker 221 can propagate to the acoustic sensors 211 on the corresponding side as well as to the acoustic sensors 211 on the opposite side. The acoustic sensors 211 on the corresponding side of the speaker 221 may be those located on the same side of the user as the speaker 221; for example, both the speaker 221 and the acoustic sensor 211 are on the user's left side. The acoustic sensors 211 on the corresponding side of the speaker 221 may also be those located on the opposite side of the user relative to the speaker 221; for example, the speaker 221 is on the user's left side, while the acoustic sensor 211 is on the user's right side.

The transfer functions from NS1, emitted by SPK1, to the corresponding-side MIC1 and MIC2 are

$${N}_{1}^{1} , {N}_{2}^{1}$$

respectively. The transfer functions from NS1 to the opposite-side MIC3 and MIC4 are

$${N}_{3}^{1} , {N}_{4}^{1} ,$$

respectively. The transfer functions from NS2, emitted by SPK2, to the opposite-side MIC1 and MIC2 are

$${N}_{1}^{2} , {N}_{2}^{2} ,$$

respectively. The transfer functions from NS2 to the corresponding-side MIC3 and MIC4 are

$${N}_{3}^{2} , {N}_{4}^{2} ,$$

respectively.

According to some exemplary embodiments of the present disclosure, after the acoustic device 200 is worn by the user, the propagation of sound from the speaker 221 to the opposite-side acoustic sensors 210 is affected by the user's head and other parts of the body. The sound emitted by the speaker 221 is primarily picked up by the corresponding-side acoustic sensors 210, which may lead to howling. Therefore, the transfer functions from the speaker 221 to the opposite side are considered to be 0, for example,

$${N}_{3}^{1} = {N}_{4}^{1} = {N}_{1}^{2} = {N}_{2}^{2} = 0 .$$

When the acoustic device 200 is worn on the user's ear(s), it can receive multiple external sounds coming from all directions. For example, as shown in FIG. 5, the external sounds may include a first external sound through an eighth external sound, FS1-FS8. The volumes of the different external sounds and their distances from the acoustic device 200 may vary. For example, the third external sound FS3 may be closer to the acoustic device 200 than the fourth external sound FS4; the fourth external sound FS4 may have a greater volume than the fifth external sound FS5.

For ease of explanation and illustration, the following description considers the case where the external sounds include a first external sound FS1 and a second external sound FS2.

The first external sound FS1 may be emitted from a first position. The first position is at a first distance from the user's face along the target direction. The second external sound FS2 may be emitted from a second position. The second position is either at a second distance from the user's face in the opposite direction along the target direction or at the user's own sound-producing location. For example, as shown in FIG. 5, the second position is at a second distance from the user's face in the opposite direction along the target direction. The first external sound FS1 and the second external sound FS2 are located in the target direction and the opposite direction of the target direction, respectively.

For example, when the acoustic device 200 is a hearing aid device, the first external sound FS1 is the sound produced by a conversational partner communicating with the user. The first distance may be selected based on experience or statistical data. For example, the first distance is 1 to 3 meters. The second external sound FS2 is a sound located behind the user. The second external sound FS2 may also be the user's own voice. The second distance may be selected based on experience or statistical data. For example, the second distance is 1.5 to 4 meters.

Within a preset auditory frequency range, the transfer functions of the first external sound FS1 to the K₁ first acoustic sensors 2101 are respectively

$${F}_{1}^{t} , {F}_{2}^{t} , … {F}_{{K}_{1}}^{t} ,$$

the transfer functions to the K₂ second acoustic sensors 2102 are respectively

$${F}_{{K}_{1} + 1}^{t} , {F}_{{K}_{1} + 2}^{t} , … {F}_{{K}_{1} + {K}_{2}}^{t} ,$$

the transfer functions to the reference listening point are at least one of

$${F}_{{r}_{1}}^{t} or {F}_{{r}_{2}}^{t} .$$

For example, the reference listening point corresponds to at least one of the first ear or the second ear. For example, the first reference point is the first ear, and the second reference point is the second ear. r₁ and r₂ respectively represent the acoustic device 200 corresponding to the first reference point and the second reference point.

$${F}_{{r}_{1}}^{t}$$

may be the transfer function from the acoustic sensor 211 to the first reference point, and

$${F}_{{r}_{2}}^{t}$$

may be the transfer function from the acoustic sensor 211 to the second reference point. Within the preset auditory frequency range, the transfer functions of the second external sound to the K₁ first acoustic sensors are respectively

$${F}_{1}^{\overline{t}} , {F}_{2}^{\overline{t}} , … {F}_{{K}_{1}}^{\overline{t}}$$

and the transfer functions to the K₂ second acoustic sensors are respectively

$${F}_{{K}_{1} + 1}^{\overline{t}} , {F}_{{K}_{1} + 2}^{\overline{t}} , … {F}_{{K}_{1} + {K}_{2}}^{\overline{t}} .$$

For example, the transfer functions of the first external sound FS1 to MIC1 and MIC2 are respectively

$${F}_{1}^{t} , {F}_{2}^{t} .$$

The transfer functions of the first external sound FS1 to MIC3 and MIC4 are respectively

$${F}_{3}^{t} , {F}_{4}^{t} .$$

The transfer functions of the second external sound FS2 to MIC1 and MIC2 are respectively

$${F}_{1}^{\overline{t}} , {F}_{2}^{\overline{t}} .$$

The transfer functions of the second external sound FS2 to MIC3 and MIC4 are respectively

$${F}_{3}^{\overline{t}} , {F}_{4}^{\overline{t}} .$$

According to some exemplary embodiments of the present disclosure, the reference listening point O also corresponds to at least one of the first acoustic sensor 2101 or the second acoustic sensor 2102. For example, the reference listening point O corresponds to MIC1 and also corresponds to MIC3.

As described above, by selecting appropriate amplitude phase modulation=(w₁, w₂, . . . . wᵢ, . . . . w_{K})^{T}, a first portion of the speaker sound corresponding to the first external sound FS1 can be made not to be attenuated at the reference listening point, while a second portion in the drive signal d is attenuated to avoid speaker howling and to form target sensitivity, where the second portion corresponds to the second external sound FS2 and internal sound components. In some exemplary embodiments, applying amplitude phase modulation to sub-signals can be implemented by a filter.

The K amplitude phase modulations correspond to K acoustic sensors 211. Attenuating the second portion in the drive signal d means reducing the intensity or amplitude of the signal of the second portion. For example, attenuating the second portion in the drive signal d is to attenuate internal signals of internal sounds and to attenuate external signals corresponding to the second external sound; attenuating internal signals of internal sounds includes attenuating internal signals of the first internal sound NS1 and/or the second internal sound NS2. The signal processing circuit 230 attenuates the second external sound in the drive signal d to form target sensitivity. The signal processing circuit 230 attenuates internal sounds to avoid speaker howling.

In some exemplary embodiments, in order to make components in the speaker sound corresponding to the first external sound not be attenuated at the reference listening point, the amplitude phase modulation w=(w₁, w₂, . . . . wᵢ, . . . . w_{K})^{T} needs to satisfy:

$$‖ {\sum }_{i = 1}^{{K}_{1}} {w}_{i} \cdot {F}_{i}^{t} ‖ = {ϵ}_{1} ‖ {F}_{{r}_{1}}^{t} ‖ \text{and/or} ‖ {\sum }_{i = 1 + {K}_{1}}^{{K}_{1} + {K}_{2}} {w}_{i} \cdot {F}_{i}^{t} ‖ = {ϵ}_{2} ‖ {F}_{{r}_{2}}^{t} ‖ .$$

The above first equation can represent that the energy after performing amplitude phase modulation on the K₁ transfer functions transmitting the first external sound is equal to a constant multiple of the energy of the transfer function transmitting the first external sound to the corresponding-side reference listening point. The above second equation can represent that the energy after performing amplitude phase modulation on the K₂ transfer functions transmitting the first external sound is equal to a constant multiple of the energy of the transfer function transmitting the first external sound to the corresponding-side reference listening point. That is, the energy of the first external sound can be kept unchanged during the transmission process from its sound source position to the acoustic device 200, and the component of the first external sound is not attenuated at the reference listening point, thereby enabling the acoustic device 200 to output the first external sound with a relatively large volume and good user listening effect.

In order to attenuate the second portion, the amplitude phase modulation=(w₁, w₂, . . . . wᵢ, . . . . w_{K})^{T} needs to minimize a combined component of the second external sound and the internal sound, which is expressed as:

$$min \{ ‖ {\sum }_{i = 1}^{K} {w}_{i} \cdot {N}_{i}^{1} ‖ + α ‖ {\sum }_{i = 1}^{K} {w}_{i} \cdot {N}_{i}^{2} ‖ + β ‖ {\sum }_{i = 1}^{{K}_{1}} {w}_{i} \cdot {F}_{i}^{\overline{t}} ‖ + γ ‖ {\sum }_{i = K 1 + 1}^{{K}_{1} + {K}_{2}} {w}_{i} \cdot {F}_{i}^{\overline{t}} ‖ \}$$

Where α, β, γ, ϵ₁, and ϵ₂ are preset constants for achieving the target sensitivity and avoiding the speaker howling, and ϵ₁, and ϵ₂ are greater than or equal to 1.

The above equation can represent minimizing the sum of the energy after performing amplitude phase modulation on the transfer functions transmitting internal sounds emitted by the speaker 221 to the corresponding-side acoustic sensors 211, and the energy after performing amplitude phase modulation on the K₁ transfer functions transmitting the second external sound. That is, the energy of the second external sound and the internal sound during the transmission process from the acoustic location to the acoustic device 200 is reduced to a minimum, for example, reduced to zero, so that the sound output again by the acoustic device 200 has a very low volume from the speaker 221, thereby avoiding or suppressing the occurrence of howling, and the volume of the second external sound is also very low, for example, far lower than the volume of the first external sound emitted by the acoustic device 200, thereby enabling the acoustic device 200 to have good spatial directivity.

For example, when the acoustic device 200 includes MIC1, MIC2, MIC3, MIC4, SPK1, and SPK2, the amplitude phase modulation needs to satisfy:

$$‖ {\sum }_{i = 1}^{2} {w}_{i} \cdot {F}_{i}^{t} ‖ = {ϵ}_{1} ‖ {F}_{{r}_{1}}^{t} ‖ and / or ‖ {\sum }_{i = 3}^{4} {w}_{i} \cdot {F}_{i}^{t} ‖ = {ϵ}_{2} ‖ {F}_{{r}_{2}}^{t} ‖ ;$$

$$min \{ ‖ {\sum }_{i = 1}^{4} {w}_{i} \cdot {N}_{i}^{1} ‖ + α ‖ {\sum }_{i = 1}^{4} {w}_{i} \cdot {N}_{i}^{2} ‖ + β ‖ {\sum }_{i = 1}^{2} {w}_{i} \cdot {F}_{i}^{\overline{t}} ‖ + γ ‖ {\sum }_{i = 3}^{4} {w}_{i} \cdot {F}_{i}^{\overline{t}} ‖ \} ;$$

$$that is :$$

$$‖ {w}_{1} \cdot {F}_{1}^{t} + {w}_{2} \cdot {F}_{2}^{t} ‖ = {ϵ}_{1} ‖ {F}_{{r}_{1}}^{t} ‖ and / or ‖ {w}_{3} \cdot {F}_{3}^{t} + {w}_{4} \cdot {F}_{4}^{t} ‖ = {ϵ}_{1} ‖ {F}_{{r}_{2}}^{t} ‖ ;$$

$$min \{ ‖ {w}_{1} \cdot {N}_{1}^{1} + {w}_{2} \cdot {N}_{2}^{1} + {w}_{3} \cdot {N}_{3}^{1} + {w}_{4} \cdot {N}_{4}^{1} ‖ + α ‖ {w}_{1} \cdot {N}_{1}^{2} + {w}_{2} \cdot {N}_{2}^{2} + {w}_{3} \cdot {N}_{3}^{2} + {w}_{4} \cdot {N}_{4}^{2} ‖ + β ‖ {w}_{1} \cdot {F}_{1}^{\overline{t}} + {w}_{2} \cdot {F}_{2}^{\overline{t}} ‖ + γ ‖ {w}_{3} \cdot {F}_{3}^{\overline{t}} + {w}_{4} \cdot {F}_{4}^{\overline{t}} ‖ \} .$$

As described above, in some exemplary embodiments,

$${N}_{3}^{1} = {N}_{4}^{1} = {N}_{1}^{2} = {N}_{2}^{2} = 0 ,$$

and the reference listening point corresponds to MIC1 and also corresponds to MIC3. Therefore, the conditions that the above amplitude phase modulation needs to satisfy are:

$$‖ {w}_{1} \cdot {F}_{1}^{t} + {w}_{2} \cdot {F}_{2}^{t} ‖ = {ϵ}_{1} ‖ {F}_{1}^{t} ‖ and / or ‖ {w}_{3} \cdot {F}_{3}^{t} + {w}_{4} \cdot {F}_{4}^{t} ‖ = {ϵ}_{1} ‖ {F}_{2}^{t} ‖ ;$$

$$min \{ ‖ {w}_{1} \cdot {N}_{1}^{1} + {w}_{2} \cdot {N}_{2}^{1} ‖ + α ‖ {w}_{3} \cdot {N}_{3}^{2} + {w}_{4} \cdot {N}_{4}^{2} ‖ + β ‖ {w}_{1} \cdot {F}_{1}^{\overline{t}} + {w}_{2} \cdot {F}_{2}^{\overline{t}} ‖ + γ ‖ {w}_{3} \cdot {F}_{3}^{\overline{t}} + {w}_{4} \cdot {F}_{4}^{\overline{t}} ‖ \} .$$

In some exemplary embodiments, the conditions that the amplitude phase modulation needs to satisfy are also:

$$‖ {\sum }_{i = 1}^{{K}_{1}} {w}_{i} \cdot {F}_{i}^{t} ‖ = {ϵ}_{1} ‖ {F}_{{r}_{1}}^{t} + {F}_{{r}_{2}}^{t} ‖ and / or ‖ {\sum }_{i = 1 + {K}_{1}}^{{K}_{1} + {K}_{2}} {w}_{i} \cdot {F}_{i}^{t} ‖ = {ϵ}_{2} ‖ {F}_{{r}_{1}}^{t} + {F}_{{r}_{2}}^{t} ‖ ;$$

$$and$$

$$min \{ ‖ {\sum }_{i = 1}^{4} {w}_{i} \cdot {N}_{i}^{1} + {w}_{i} \cdot {N}_{i}^{2} ‖ + β ‖ {\sum }_{i = 1}^{4} {w}_{i} \cdot {F}_{i}^{\overline{t}} ‖ \} .$$

There are more variations of the conditions that the amplitude phase modulation needs to satisfy. In the present disclosure, no limitation is made, as long as the functions mentioned in the present disclosure can be achieved without departing from the spirit of the present disclosure, they all fall within the protection scope of the present disclosure. The amplitude phase modulation obtained by the above method enables the acoustic device 200 to suppress howling and have good spatial directivity.

In some exemplary embodiments, the dot product of the transfer function and the amplitude phase modulation represents a convolution of the transfer function with the amplitude phase modulation. The convolution can be implemented by a filter. For example, the convolution is implemented by the filter element module 235 in FIG. 2, or by the processor 232 executing a corresponding instruction set stored in the memory 231. The filter element module 235 includes K filters. Each filter corresponds to one acoustic sensor 211.

In some exemplary embodiments, when the acoustic device 200 only implements unilateral feedback reduction and spatial directivity, the above K₂ is set to 0, thereby obtaining the corresponding amplitude phase modulation formula.

In some exemplary embodiments, the above minimization formula is solved by using methods such as gradient descent, Lagrange, or convex optimization.

In some exemplary embodiments, before solving, the tester collects sufficient transfer function data. Transfer function information is collected from multiple people, multiple wearings, and multiple spatial angles, serving as the input for the above solving; the external sound is a sweep signal or other signals from which the corresponding transfer function can be obtained.

A person skilled in the art understands that the acoustic device 200 can receive more external sounds and process them. For example, the external sounds include the above eight external sounds, FS1 to FS8. For example, in one scenario, a user wants to retain sounds located on their left side, such as FS3 to FS5, and wants to block the remaining sounds, such as FS1 to FS2 and FS6 to FS8. Similarly, the acoustic device 200 can use the above method to perform amplitude phase modulation on the transfer functions, by reducing, maintaining, or increasing the energy of external sounds, thereby meeting the user's auditory needs. No limitation is made in the present disclosure, as long as the functions mentioned in the present disclosure can be achieved without departing from the spirit of the present disclosure.

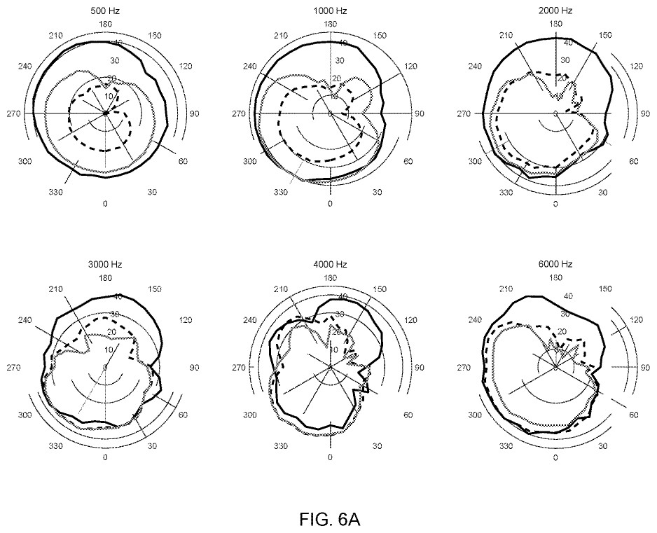

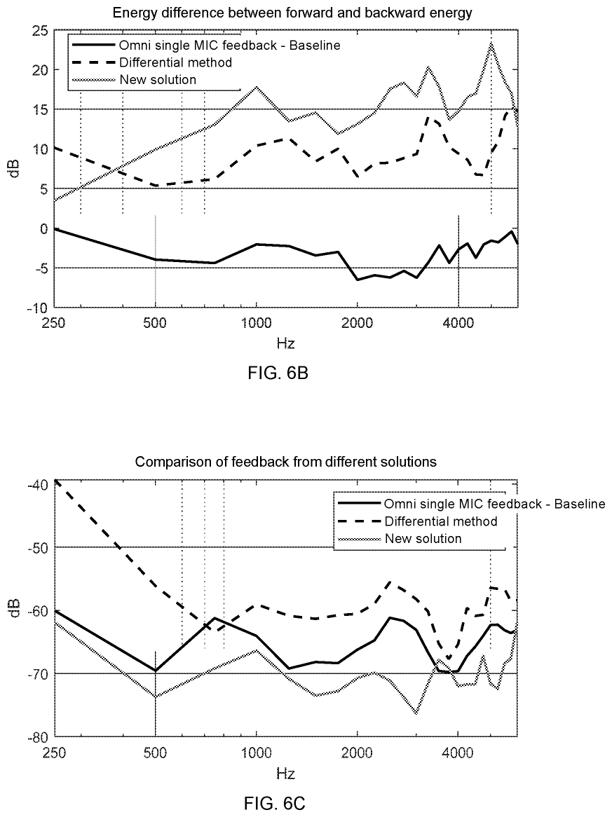

FIG. 6A illustrates a sensitivity diagram of an acoustic device provided according to some exemplary embodiments of the present disclosure. FIGS. 6B and 6C respectively illustrate schematic diagrams of energy comparison and feedback comparison under different schemes provided according to some exemplary embodiments of the present disclosure. FIG. 6A is a sensitivity diagram when the first acoustic sensor 2101 includes three acoustic sensors 211. In FIGS. 6A, 6B, and 6C, the black solid line represents the sensitivity of the acoustic device 200 using a single acoustic sensor, the black dashed line represents the sensitivity when using classical differentiation, and the gray dashed line represents the sensitivity of the acoustic device 200 when using the target operation provided by the present disclosure.

As shown in FIGS. 6A to 6C, compared with using classical differentiation, the target operation provided by the present disclosure enables the acoustic device 200 to achieve better sound attenuation than the differentiation scheme in the rearward direction (180°) across most frequency bands, and also provides good directivity and feedback attenuation for mid-to-high frequencies.

As described above, the acoustic device 200 is an ear hook hearing aid device. Among the K acoustic sensors 211, there are K₁ first acoustic sensors 2101 and K₂ second acoustic sensors 2102. The first acoustic sensors 2101 correspond to the user's first ear, and the second acoustic sensors 2102 correspond to the user's second ear. The speaker module 220 includes a first speaker 2201 corresponding to the first ear and a second speaker 2202 corresponding to the second ear. The following description is made only with respect to the first acoustic sensor 2101 as an example; the second acoustic sensors 2102 have a similar or identical structure, and are not further described herein.

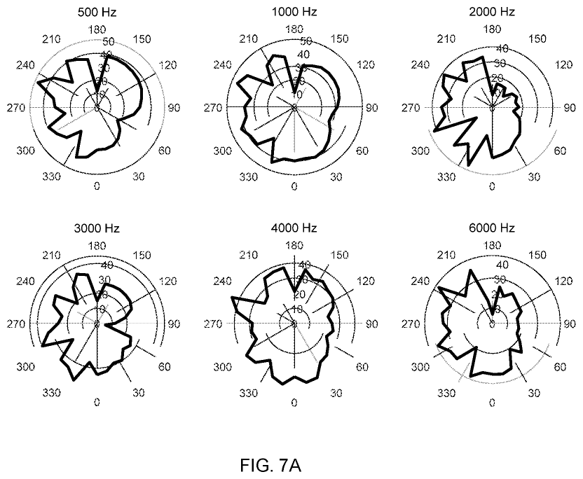

In some exemplary embodiments, the number of K₁ first acoustic sensors 2101 is at least three. At least three first acoustic sensors 2101 are arranged non-linearly. FIG. 7A illustrates a sensitivity distribution diagram of the acoustic device 200 when three first acoustic sensors 2101 are arranged linearly. FIG. 7B illustrates a sensitivity distribution diagram of the acoustic device 200 when three first acoustic sensors 2101 are arranged non-linearly.

As shown in FIGS. 7A and 7B, compared with the first acoustic sensors 2101 arranged linearly, when the first acoustic sensors 2101 are arranged non-linearly, the acoustic device 200 achieves better sound attenuation in the rearward direction (180°) across most frequency bands, and also provides good directivity and feedback attenuation for mid-to-high frequencies.

In some exemplary embodiments, the number of K₁ first acoustic sensors 2101 is three. The three acoustic sensors 211 are arranged in a triangular distribution. The angle formed by connecting any two of the three first acoustic sensors 2101 is an acute or right angle, i.e., a non-obtuse angle. For example, the angle formed by the connecting lines is an acute angle or a right angle. This is because, assuming one side of the triangle is fixed and at the same height, a non-obtuse angle compared to an obtuse angle has a shorter distance between the acoustic sensors, and the spacing between the acoustic sensors 211 can affect the frequency bandwidth of beamforming; the shorter the distance, the larger the bandwidth that can be processed.

In some exemplary embodiments, the distance between any two of the K₁ first acoustic sensors 2101 is greater than 0.5 cm and less than 3 cm. For example, the distance between two first acoustic sensors 2101 can be 1 cm, 1.5 cm, 2 cm, 2.5 cm, and so on. This is because if the spacing between the acoustic sensors 211 is too large, the processed bandwidth may decrease; if the spacing between the acoustic sensors 211 is too small, it becomes difficult to capture the differences of feedback on each acoustic sensor 211, which may reduce the feedback cancellation effect.

In some exemplary embodiments, the distance between the centroid of the K₁ first acoustic sensors 2101 and the centroid of the first speaker 2201 ranges from 5 to 10 cm. The centroid of the first speaker 2201 refers to the geometric center of the first speaker 2201. The centroid of the K₁ first acoustic sensors 2101 refers to the geometric center of the masses of the K₁ first acoustic sensors 2101. For example, the distance between the centroid of the first acoustic sensors 2101 and the first speaker 2201 can be 5 cm, 6 cm, 7 cm, 8 cm, and so on. This is because, at this distance scale, the response differences from the speaker 221 to the acoustic sensors 211 can be significantly distinguished from sound sources in the target direction.

In some exemplary embodiments, among the multiple lines connecting the K₁ first acoustic sensors 2101 and the centroid of the first speaker 2201, at least two of the lines form an angle greater than 6°, and the angle formed by any two lines is less than 20°. For example, the angle between two lines connecting two first acoustic sensors 2101 and the centroid of the first speaker 2201 can be 10°, 15°, and so on. This is because, at this angle scale, the response differences from the speaker 221 to the acoustic sensors 211 can be significantly distinguished from sound sources in the target direction.

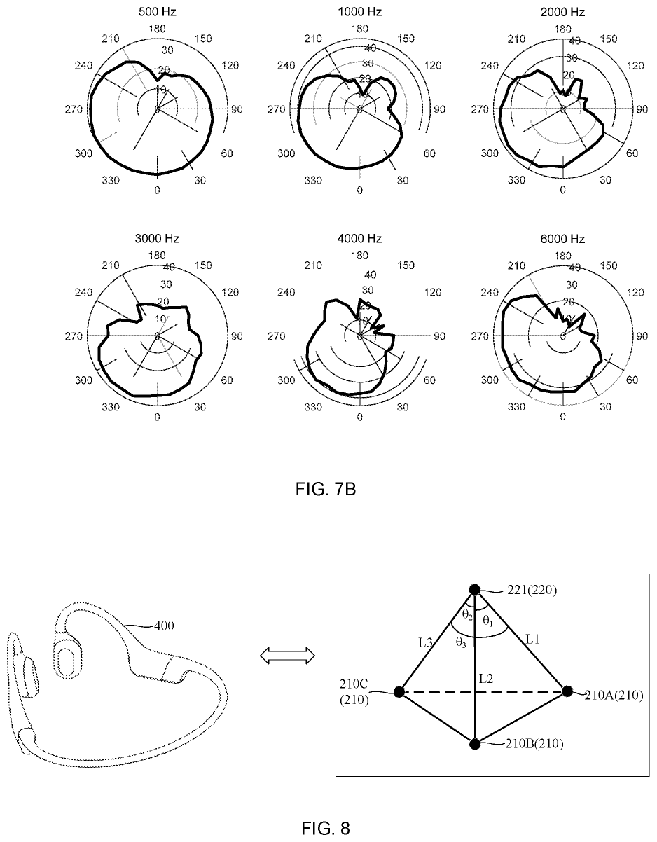

The present disclosure also provides an ear hook hearing aid device. FIG. 8 illustrates an ear hook hearing aid device 400 provided according to some exemplary embodiments of the present disclosure, as well as a schematic diagram of the internal structure of the ear hook hearing aid device 400. As shown in FIG. 8, the ear hook hearing aid device 400 includes an acoustic sensor module 210 and a speaker module 220. The acoustic sensor module 210 includes at least three acoustic sensors 211. For example, the acoustic sensor module 210 may include three acoustic sensors 211. As another example, the acoustic sensor module 210 may include five acoustic sensors 211. At least three acoustic sensors 211 are arranged non-linearly. When the user wears the hearing aid, the speaker module 220 is located at the front side of the user's auricle, and the acoustic sensor module 210 is located at the rear side of the auricle. In this way, on one hand, it facilitates the acoustic sensors 211 to pick up environmental sounds, and on the other hand, minimizes the pickup of sounds emitted by the speaker module 220 by the acoustic sensor module 210. The acoustic sensor module 210 and the speaker module 220 are the same as or of the same type as the acoustic sensor module 210 and the speaker module 220 provided in the embodiments of FIGS. 1 to 7B. The sensitivity comparison diagrams when the multiple acoustic sensors 211 in the ear hook hearing aid device 400 are arranged non-linearly and linearly can refer to FIGS. 7A and 7B, and are not repeated herein.

In some exemplary embodiments, the acoustic sensor module 210 includes three acoustic sensors 211, and the three acoustic sensors 211 are arranged in an acute triangle or a right triangle. The arrangement in an acute triangle or right triangle means that the triangle formed by connecting the centroids of any two of the three acoustic sensors 211 is an acute or right triangle. The centroid of an acoustic sensor 211 can be the geometric center of its mass or the geometric center of its position. This is because, assuming one side of the triangle is fixed and at the same height, a non-obtuse angle compared to an obtuse angle has a shorter distance between the acoustic sensors, and the spacing between the acoustic sensors 211 can affect the frequency bandwidth of beamforming; the shorter the distance, the larger the bandwidth the acoustic sensors 211 can process.

As shown in FIG. 8, the acoustic sensor module 210 may include acoustic sensor 210A, acoustic sensor 210B, and acoustic sensor 210C. Among them, the three acoustic sensors 211 are arranged in an acute triangle.

In some exemplary embodiments, the distance between any two of the at least three acoustic sensors is greater than 0.5 cm and less than 3 cm. For example, the distance between two acoustic sensors 211 can be 1 cm, 1.5 cm, 2 cm, 2.5 cm, and so on. This is because if the spacing between the acoustic sensors 211 is too large, the processed bandwidth may decrease; if the spacing between the acoustic sensors 211 is too small, it becomes difficult to capture the differences of feedback on each acoustic sensor 211, which may reduce the feedback cancellation effect.

In some exemplary embodiments, the distance between the centroid of the positions of at least three acoustic sensors 210 and the centroid of the position of the speaker module 220 ranges from 5 to 10 cm. For example, the distance between the centroids of the acoustic sensors 211 and the speaker module 220 can be 5 cm, 6 cm, 7 cm, 8 cm, and so on. This is because, at this distance scale, the response differences from the speaker 221 to the acoustic sensors 211 can be significantly distinguished from sound sources in the target direction.

In some exemplary embodiments, among the multiple lines connecting at least three acoustic sensors 210 and the speaker module 220, at least two of the lines form an angle greater than 6°, and the angle formed by any two lines is less than 20°. For example, the angle between two lines connecting two acoustic sensors 211 and the centroid of the speaker 221 can be 10°, 15°, and so on. This is because, at this angle scale, the response differences from the speaker 221 to the acoustic sensors 211 can be significantly distinguished from sound sources in the target direction.

As shown in FIG. 8, the speaker module 220 may include a speaker 221. The line connecting acoustic sensor 210A and speaker 221 is L1; the line connecting acoustic sensor 210B and speaker 221 is L2; the line connecting acoustic sensor 210C and speaker 221 is L3. The angle between L1 and L2 can be 01; the angle between L1 and L3 can be θ2; the angle between L2 and L3 can be θ3, 6°<θ1<20°; 6°<θ2<20°; 6°<θ3<20°, θ1, θ2, and θ3 can be the same or different.

It is worth noting that the positional relationship between the acoustic sensor module 210 and the speaker module 220 shown in FIG. 8 is only schematic, and their actual positions inside the ear hook hearing aid 400 may be the same as or different from those shown in the figure.

In summary, the acoustic device 200 provided in the present disclosure has a sensitivity of less than 3 dB to internal sounds emitted from the position of the speaker module 220, so that the speaker 221 does not amplify or only minimally amplifies the sounds received by the acoustic sensor module 210 from the speaker 211, thereby achieving the effect of suppressing howling. The acoustic device 200 has the highest sensitivity in the target direction, so that the speaker 211 provides the best amplification of external sounds from the target direction, thereby achieving good spatial directivity. In conclusion, the acoustic device 200 provided in this disclosure not only achieves good spatial directivity but also effectively suppresses howling, providing the user with a better acoustic experience. Additionally, in the ear hook hearing aid 400 provided in the present disclosure, the multiple acoustic sensors 211 are arranged non-linearly, which allows the ear hook hearing aid 400 to have better spatial directivity and to more effectively avoid or suppress the occurrence of howling.

On the other hand, the present disclosure provides a non-transitory storage medium storing at least one set of executable instructions for signal processing. When the executable instructions are executed by a processor, the instructions guide the processor to implement the target operation P100 described in the present disclosure. In some possible embodiments, various aspects of the present disclosure are also implemented in the form of a program product, which includes program code. When the program product is executed on the acoustic device 200, the program code is configured to cause the acoustic device 200 to perform the steps of the target operation P100 described in the present disclosure. The program product for implementing the above method may be stored on a portable compact disc read-only memory (CD-ROM) including the program code and executed on the acoustic device 200. However, the program product of the present disclosure is not limited thereto. In the present disclosure, a readable storage medium is any tangible medium that contains or stores a program, which is used by or in combination with an instruction execution system. The program product may use any combination of one or more readable media. The readable medium may be a readable signal medium or a readable storage medium. Examples of readable storage media include, but are not limited to, systems, devices, or apparatuses using electrical, magnetic, optical, electromagnetic, infrared, or semiconductor methods, or any combination thereof. More specific examples of readable storage media include, but are not limited to, electrical connections with one or more wires, portable disks, hard disks, random access memory (RAM), read-only memory (ROM), erasable programmable read-only memory (EPROM or flash memory), optical fibers, portable compact disc read-only memory (CD-ROM), optical storage devices, magnetic storage devices, or any suitable combination thereof. The computer-readable storage medium also includes data signals propagated in a baseband or as part of a carrier wave, carrying readable program code. Such propagated data signals take various forms, including but not limited to electromagnetic signals, optical signals, or any suitable combination thereof. The readable medium also includes any readable medium other than a storage medium, which transmits, propagates, or transports a program for use by or in combination with an instruction execution system, device, or apparatus. Program code stored on a readable medium can be transmitted by any suitable means, including but not limited to wireless, wired, optical cable, RF, or any suitable combination thereof. The program code for performing the operations of the present disclosure may be written in any combination of one or more programming languages, including object-oriented programming languages, such as Java, C++, and conventional procedural programming languages, such as “C” or similar programming languages. The program code may be executed entirely on the acoustic device 200, partially on the acoustic device 200, as a standalone software package, partially on the acoustic device 200 and partially on a remote computing device, or entirely on a remote computing device.

The specific embodiments of the present disclosure have been described above. Other embodiments fall within the scope of the appended claims. In some cases, the actions or steps recited in the claims may be performed in an order different from that described in the embodiments and still achieve the desired results. Moreover, the processes depicted in the accompanying drawings do not necessarily require a particular or sequential order to achieve the desired results. In certain embodiments, multitasking and parallel processing are also possible or may be advantageous.

In summary, after reading this detailed disclosure, a person skilled in the art will understand that the foregoing detailed disclosure is presented by way of example only and is not limiting. Although not explicitly stated herein, a person skilled in the art will understand that this disclosure encompasses various reasonable variations, improvements, and modifications to the embodiments. These variations, improvements, and modifications are intended to be suggested by this disclosure and are within the spirit and scope of the exemplary embodiments of this disclosure.

In addition, certain terms in this disclosure have been used to describe embodiments of the present disclosure. For example, “an embodiment,” “embodiment,” and/or “some exemplary embodiments” mean that the particular features, structures, or characteristics described in connection with that embodiment are included in at least one embodiment of this disclosure. Therefore, it should be emphasized and understood that two or more references to “embodiment” or “an embodiment” or “alternative embodiment” in various portions of this disclosure do not necessarily refer to the same embodiment. Furthermore, particular features, structures, or characteristics may be appropriately combined in one or more embodiments of this disclosure.

It should be understood that in the foregoing description of embodiments of this disclosure, in order to aid understanding of a feature and for the purpose of simplifying the disclosure, various features have been combined in a single embodiment, figure, or its description. However, this does not mean that the combination of these features is required. A person skilled in the art, when reading this disclosure, can fully recognize that some of the devices or features may be considered as separate embodiments. In other words, the embodiments in this disclosure can also be understood as an integration of multiple sub-embodiments. Each sub-embodiment is valid even when it includes fewer features than all of the features of a single aforementioned disclosed embodiment.

Finally, it should be understood that the embodiments of the application disclosed herein are illustrative of the principles of the disclosure. Other modified embodiments also fall within the scope of this disclosure. Therefore, the embodiments disclosed in this disclosure are provided by way of example only and are not limiting. A person skilled in the art may adopt alternative configurations based on the embodiments disclosed herein to implement the disclosure. Accordingly, the embodiments of this disclosure are not limited to those described in the application.

What is claimed is:

1. An acoustic device for assisting a user in obtaining sounds arriving from a neighborhood along a target direction, comprising:
an acoustic sensor module, comprising a plurality of acoustic sensors, configured to collect surrounding sound during operation and generate sensor signals, wherein the surrounding sound comprises an external sound from outside the acoustic device and an internal sound emitted from a position of a speaker module;
the speaker module, configured to receive a drive signal during operation and output a speaker sound; and
a signal processing circuit, communicatively connected to the acoustic sensor module and the speaker module, configured to perform, during operation, a target operation based on the sensor signals to generate the drive signal, such that the speaker sound satisfies a target sensitivity with respect to the surrounding sound, wherein
the target sensitivity is that, within a preset auditory frequency range, a sensitivity distribution of the acoustic device to the external sound is directional and has a maximum value in the target direction, and a speaker sensitivity to the internal sound is less than 3 dB.

2. The acoustic device according to claim 1, wherein the sensitivity distribution of the acoustic device to the external sound being directional is that: an average sensitivity of the acoustic device to the external sound within a listening field of a preset angle has a unique maximum value over a 360° range around the acoustic device, wherein
the listening field of the preset angle is a sector region with a reference listening point as a center and a center angle as the preset angle, and the reference listening point comprises at least one of the user's eardrum, the acoustic sensor module, or the speaker module.

3. The acoustic device according to claim 2, wherein the acoustic device is an ear hook hearing aid device; and when the acoustic device is worn on the user's ear, the speaker module is located on a front side of the user's auricle, a sound output end of the speaker module faces toward the user's ear, and a pickup end of the acoustic sensor module is located on a rear side of the auricle.

4. The acoustic device according to claim 3, wherein when the acoustic device is worn on the user's ear, the target direction is a direction toward a sound-emitting part of the user, or the target direction is a facing direction of the user's face, and the listening field is oriented away from the acoustic sensor module.

5. The acoustic device according to claim 4, wherein the external sound comprises a first external sound and a second external sound, the first external sound is emitted from a first position, the first position is in the target direction, the second external sound is emitted from a second position, the second position is in a direction opposite to the target direction, and the acoustic device has a sensitivity lower than 3 dB for the second external sound.

6. The acoustic device according to claim 4, wherein the external sound comprises a first external sound and a second external sound, the first external sound is emitted from a first position, the first position is in the target direction, the second external sound is emitted from a second position, the second position is, when the user wears the acoustic device, a sound-emitting location of the user, and the acoustic device has a sensitivity lower than 3 dB for the second external sound.

7. The acoustic device according to claim 1, wherein the plurality of acoustic sensors comprises K acoustic sensors, K being a positive integer, the K acoustic sensors generate K sub-signals s₁, s₂, . . . . s_{K} during operation, a sensor signal s comprises the K sub-signals, s=(s₁, s₂, . . . . s_{K})^{T};
to generate the drive signal based on the sensor signal, the signal processing circuit is configured to:
filter the sensor signal s to obtain filtered sub-signals \tilde{s}, \tilde{s}=(\tilde{s}₁, \tilde{s}₂, . . . \tilde{s}_{K})^{T}, wherein \tilde{s}₁, \tilde{s}₂, . . . \tilde{s}_{K} are K filtered sub-signals corresponding to the K sub-signals; and
generate the drive signal based on the filtered sub-signals \tilde{s}, wherein the drive signal has a directivity in response to the external sound and has a maximum value in the target direction, and at the same time attenuates a response within the drive signal to the internal sound.

8. The acoustic device according to claim 7, wherein to obtain the filtered sub-signals \tilde{s} and generate the drive signal, the signal processing circuit is configured to:
respectively apply corresponding amplitude phase modulation wᵢ to each sub-signal \tilde{s} in the sensor signal s, to generate corresponding filtered sub-signals \tilde{s}ᵢ in the filtered signal \tilde{s}, wherein i is any integer between 1 and K; and
obtain the drive signal based on a sum of K filtered sub-signals.

9. The acoustic device according to claim 8, wherein
the user's ear comprises at least one of a first or a second ear;
the K acoustic sensors comprise K1 first acoustic sensors and K2 second acoustic sensors, wherein the first acoustic sensors correspond to the first ear, the second acoustic sensors correspond to the second ear, K1+K2=K, and both K1 and K2 are integers; and
the speaker module comprises at least one of a first speaker corresponding to the first ear or a second speaker corresponding to the second ear.

10. The acoustic device according to claim 9, wherein
the internal sound comprises a first internal sound and a second internal sound, the first internal sound is emitted from a position of the first speaker, and the second internal sound is emitted from a position of the second speaker;
transfer functions between the first internal sound and the K1 first acoustic sensors are respectively
$${N}_{1}^{1} , {N}_{2}^{1} , … {N}_{{K}_{1}}^{1} ,$$
and transfer functions between the first internal sound and the K2 second acoustic sensors are respectively
$${N}_{{K}_{1} + 1}^{1} , {N}_{{K}_{1} + 2}^{1} , … {N}_{{K}_{1} + {K}_{2}}^{1} ;$$
transfer functions between the second internal sound and the K₁ first acoustic sensors are respectively
$${N}_{1}^{2} , {N}_{2}^{2} , … {N}_{{K}_{1}}^{2} ,$$
and transfer functions between the second internal sound and the K2 second acoustic sensors are respectively
$${N}_{{K}_{1} + 1}^{2} , {N}_{{K}_{1} + 2}^{2} , … {N}_{{K}_{1} + {K}_{2}}^{2} ;$$
when the acoustic device is worn on the user's ear, the external sound comprises a first external sound and a second external sound, the first external sound is emitted from a first position, and the first position is at a first distance away from the user's face along the target direction, the second external sound is emitted from a second position, the second position comprises a position at a second distance away from the user's face along a direction opposite to the target direction, or a sound-emitting position of the user;
within the preset auditory frequency range, transfer functions from the first external sound to the K1 first acoustic sensors are respectively
$${F}_{1}^{t} , {F}_{2}^{t} , … {F}_{{K}_{1}}^{t} ,$$
transfer functions to the K2 second acoustic sensors are respectively
$${F}_{{K}_{1} + 1}^{t} , {F}_{{K}_{1} + 2}^{t} , … {F}_{{K}_{1} + {K}_{2}}^{t} ,$$
and transfer functions to the reference listening point are at least one of
$${F}_{{r}_{1}}^{t} or {F}_{{r}_{2}}^{t} ,$$
wherein the reference listening point corresponds to at least one of the first ear or the second ear, and r₁ represents the reference listening point of the acoustic device corresponding to the first ear and r₂ represents the reference listening point of the acoustic device corresponding to the second ear;
within the preset auditory frequency range, transfer functions from the second external sound to the K1 first acoustic sensors are respectively
$${F}_{1}^{\overline{t}} , {F}_{2}^{\overline{t}} , … {F}_{{K}_{1}}^{\overline{t}} ,$$
and transfer functions to the K2 second acoustic sensors are respectively
$${F}_{{K}_{1} + 1}^{\overline{t}} , {F}_{{K}_{1} + 2}^{\overline{t}} , … {F}_{{K}_{1} + {K}_{2}}^{\overline{t}} ;$$
and
the amplitude phase modulation=(w₁, w₂, . . . . wᵢ, . . . . w_{K})^{T} enables a first part, corresponding to the first external sound, of the speaker sound not to be attenuated at the reference listening point, and enables a second part of the drive signal to be attenuated to avoid occurrence of speaker howling and to form the target sensitivity, wherein the second part corresponds to the second external sound and internal sound components.

11. The acoustic device according to claim 10, wherein
to enable a component corresponding to the first external sound in the speaker sound not to be attenuated at the reference listening point, the amplitude phase modulation=(w₁, w₂, . . . . wᵢ, . . . . w_{K})^{T} satisfies at least one of
$$‖ {\sum }_{i = 1}^{{K}_{1}} {w}_{i} \cdot {F}_{i}^{t} ‖ = {ϵ}_{1} ‖ {F}_{{r}_{1}}^{t} ‖ or ‖ {\sum }_{i = 1 + {K}_{1}}^{{K}_{1} + {K}_{2}} {w}_{i} \cdot {F}_{i}^{t} ‖ = {ϵ}_{2} ‖ {F}_{{r}_{2}}^{t} ‖ ;$$
and
to enable the second part to be attenuated, the amplitude phase modulation w=(w₁, w₂, . . . . wᵢ, . . . . w_{K})^{T} minimize a combined component of the second external sound and the internal sound, expressed as:
$$min \{ ‖ {\sum }_{i = 1}^{K} {w}_{i} \cdot {N}_{i}^{1} ‖ + α ‖ {\sum }_{i = 1}^{K} {w}_{i} \cdot {N}_{i}^{2} ‖ + β ‖ {\sum }_{i = 1}^{{K}_{1}} {w}_{i} \cdot {F}_{i}^{\overline{t}} ‖ + γ ‖ {\sum }_{i = K 1}^{{K}_{1} + {K}_{2}} {w}_{i} \cdot {F}_{i}^{\overline{t}} ‖ \} ,$$
wherein α, β, γ, ϵ₁, and ϵ₂ are preset constants for achieving the target sensitivity and avoiding the speaker howling, and ϵ₁, and ϵ₂ are greater than or equal to 1.

12. The acoustic device according to claim 1, wherein
the acoustic device is an ear hook hearing aid device, configured to be worn on the user's ear, wherein the user's ear comprises at least one of a first ear or a second ear;
the plurality of acoustic sensors comprises K acoustic sensors, wherein K is a positive integer;
the K acoustic sensors comprise K1 first acoustic sensors and K2 second acoustic sensors, wherein the first acoustic sensors correspond to the first ear, the second acoustic sensors correspond to the second ear, K1+K2=K, and both K1 and K2 are integers; and
the speaker module comprises a first speaker corresponding to the first ear and a second speaker corresponding to the second ear.

13. The acoustic device according to claim 12, wherein a quantity of the K1 first acoustic sensors is at least 3, and the at least 3 first acoustic sensors are arranged non-linearly.

14. The acoustic device according to claim 13, wherein the quantity of the K1 first acoustic sensors is 3, and the 3 first acoustic sensors are distributed in a triangular pattern; and an angle formed by a line connecting any two of the 3 first acoustic sensors is not an obtuse angle.

15. The acoustic device according to claim 12, wherein the acoustic device has at least one of the following features:
a distance between any two of the K1 first acoustic sensors is greater than 0.5 cm and less than 3 cm;
a distance between a centroid of the K1 first acoustic sensors and a centroid of the first speaker is in a range of 5 to 10 cm; or
among multiple lines connecting the K1 first acoustic sensors and a centroid of the first speaker, at least two lines form an angle greater than 6°, and an angle formed by any two lines is less than 20°.

16. The acoustic device according to claim 1, wherein the signal processing circuit comprises:
at least one filter element module in communication with the acoustic sensor module, and configured to filter the sensor signals during operation.

17. The acoustic device according to claim 1, wherein the signal processing circuit comprises:
at least one storage medium, storing at least one set of instructions, configured to generate the drive signal based on the target sensitivity, such that the speaker sound satisfies the target sensitivity with respect to the surrounding sound; and
at least one processor, in communication with the at least one storage medium, the acoustic sensor module, and the speaker module, wherein the at least one processor executes the at least one set of instructions during operation to perform the target operation based on the sensor signals to generate the drive signal.

18. An ear hook hearing aid device, comprising:
an acoustic sensor module, comprising at least 3 acoustic sensors, wherein the at least 3 acoustic sensors are arranged non-linearly; and
a speaker module, wherein when a user wears the hearing aid device, the speaker module is located at a front side of the user's auricle, and the acoustic sensor module is located at a rear side of the user's auricle.

19. The hearing aid device according to claim 18, wherein the acoustic sensor module comprises 3 acoustic sensors, and the 3 acoustic sensors are distributed in an acute-angled triangle or a right-angled triangle.

20. The hearing aid device according to claim 18, wherein the hearing aid device has at least one of the following features:
a distance between any two of the at least 3 acoustic sensors is greater than 0.5 cm and less than 3 cm;
a distance between a centroid of the at least 3 acoustic sensors and a centroid of the speaker module is in a range of 5 to 10 cm; or
among multiple lines connecting the at least 3 acoustic sensors and the speaker module, at least two lines form an angle greater than 6°, and an angle formed by any two lines is less than 20°.
